(19) United States
(12) Patent Application Publication
(10) Pub. No.: US 2024/0186057 A1
(43) Pub. Date: Jun. 6, 2024

(54) TRANSFORMER STRUCTURE WITH BIFILAR WINDINGS

(71) Applicant: University of Florida Research Foundation, Incorporated, Gainesville, FL (US)

(72) Inventors: Shuo Wang, Gainesville, FL (US); Qinghui Huang, Gainesville, FL (US)

(21) Appl. No.: 18/528,612

(22) Filed: Dec. 4, 2023

Related U.S. Application Data
(60) Provisional application No. 63/430,443, filed on Dec. 6, 2022.

(51) Int. Cl. H01F 27/28; H01F 1/03; H01F 27/32

(52) U.S. Cl. CPC H01F 27/2823; H01F 1/0315; H01F 27/325

(57) ABSTRACT

A transformer is provided. The transformer includes a core; a primary winding including a first wire and a second wire electrically connected in series, where the first wire and the second wire are bifilar-wound around the core; and a secondary winding including a third wire wound around the core.

### CROSS-REFERENCE TO RELATED APPLICATIONS

The present application claims priority to U.S. Provisional Application Ser. No. 63/430,443, titled “TRANSFORMER STRUCTURE WITH BIFILAR WINDINGS,” filed Dec. 6, 2022, the contents of which are incorporated herein by reference in their entirety.

### TECHNICAL FIELD

The present application relates to the technical field of a transformer structure. In particular, the invention relates to a transformer structure with bifilar windings.

### BACKGROUND

Isolated converters have been widely deployed in many fields, such as consumer electronics, and medical power supply. Transformers are key components in isolated converters and isolate input connections and output connections in order to meet safety requirements. However, common mode (CM) noises caused by switching action of power devices are generated from the isolated converters. Many technical challenges and difficulties associated with reducing the common mode (CM) noises have been identified. Through applied effort, ingenuity, and innovation, many of these identified problems have been solved by developing solutions that are included in embodiments of the present disclosure, many examples of which are described in detail herein.

### BRIEF SUMMARY

Various embodiments described herein relate to a device for a transformer with bifilar windings.

In accordance with various embodiments of the present disclosure, a transformer is provided. The transformer includes a core; and a primary winding including a first wire and a second wire electrically connected in series, where the first wire and the second wire are bifilar-wound around the core; and a secondary winding including a third wire wound around the core.

In some embodiments, the transformer further includes a bobbin between the core and the primary winding and between the core and the secondary winding.

In some embodiments, the first wire includes a first portion of the first wire and a second portion of the first wire; and the first portion of the first wire is wound in a first winding layer of the transformer, and the second portion of the first wire is wound in a second winding layer of the transformer.

In some embodiments, the second wire includes a first portion of the second wire and a second portion of the second wire; and the first portion of the second wire is wound in the first winding layer of the transformer, and the second portion of the second wire is wound in the second winding layer of the transformer.

In some embodiments, the first portion of the first wire, the second portion of the first wire, the second portion of the second wire, and the first portion of the second wire are electrically connected in a sequential order.

In some embodiments, the secondary winding further includes a fourth wire electrically connected with the third wire in series, where the third wire and the fourth wire are bifilar-wound around the core.

In some embodiments, the third wire includes a first portion of the third wire and a second portion of the third wire; and the first portion of the third wire is wound in a third winding layer of the transformer, and the second portion of the third wire is wound in a fourth winding layer of the transformer.

In some embodiments, the fourth wire includes a first portion of the fourth wire and a second portion of the fourth wire; and the first portion of the fourth wire is wound in the third winding layer of the transformer, and the second portion of the fourth wire is wound in the fourth winding layer of the transformer.

In some embodiments, the first portion of the third wire, the second portion of the third wire, the second portion of the fourth wire, and the first portion of the fourth wire are electrically connected in a sequential order.

In some embodiments, the core is made of a ferrite material.

In accordance with various embodiments of the present disclosure, a transformer is provided. The transformer includes a core, a secondary winding including a first wire and a second wire electrically connected in series, where the first wire and the second wire are bifilar-wound around the core, and a primary winding including a third wire wound around the core.

In some embodiments, the transformer further includes a bobbin between the core and the primary winding and between the core and the secondary winding.

In some embodiments, the first wire includes a first portion of the first wire and a second portion of the first wire; and the first portion of the first wire is wound in a first winding layer of the transformer, and the second portion of the first wire is wound in a second winding layer of the transformer.

In some embodiments, the second wire includes a first portion of the second wire and a second portion of the second wire; and the first portion of the second wire is wound in the first winding layer of the transformer, and the second portion of the second wire is wound in the second winding layer of the transformer.

In some embodiments, the first portion of the first wire, the second portion of the first wire, the second portion of the second wire, and the first portion of the second wire are electrically connected in a sequential order.

In some embodiments, the primary winding further includes a fourth wire electrically connected with the third wire in series, where the third wire and the fourth wire are bifilar-wound around the core.

In some embodiments, the third wire includes a first portion of the third wire and a second portion of the third wire; and the first portion of the third wire is wound in a third winding layer of the transformer, and the second portion of the third wire is wound in a fourth winding layer of the transformer.

In some embodiments, the fourth wire includes a first portion of the fourth wire and a second portion of the fourth wire; and the first portion of the fourth wire is wound in the third winding layer of the transformer, and the second portion of the fourth wire is wound in the fourth winding layer of the transformer.

In some embodiments, the first portion of the third wire, the second portion of the third wire, the second portion of the fourth wire, and the first portion of the fourth wire are electrically connected in a sequential order.

In some embodiments, the core is made of a ferrite material.

### BRIEF DESCRIPTION OF THE DRAWINGS

The accompanying drawings, which constitute a part of the description, illustrate embodiments of the present invention and, together with the description thereof, serve to explain the principles of the present invention.

FIG. 1A provides an example circuit diagram for a CM model for flyback converter of a converter circuit with voltage and current sources, according to some embodiments of the present disclosure.

FIG. 1B provides an example circuit diagram for a CM model for a flyback converter of substitute nonlinear devices with voltage and current sources, according to some embodiments of the present disclosure.

FIG. 2A provides an example circuit diagram for a CM model for a two-switch forward converter of a converter circuit with voltage and current sources, according to some embodiments of the present disclosure.

FIG. 2B provides an example circuit diagram for a CM model for a two-switch forward converter of substitute nonlinear devices with voltage and current sources, according to some embodiments of the present disclosure.

FIG. 3A provides an example circuit diagram for a CM model of a transformer for a two-switch forward converter of an original transformer, according to some embodiments of the present disclosure.

FIG. 3B provides an example circuit equivalent diagram for a CM model of a transformer for a two-switch forward converter of a two-capacitor model, according to some embodiments of the present disclosure.

FIG. 4A provides an example circuit diagram for a CM model of a transformer for a flyback converter of an original transformer, according to some embodiments of the present disclosure.

FIG. 4B provides an example circuit equivalent diagram for a CM model of a transformer for a flyback converter of a two-capacitor model, according to some embodiments of the present disclosure.

FIG. 5A provides an example circuit diagram for a CM model of an original transformer, according to some embodiments of the present disclosure.

FIG. 5B provides an example circuit equivalent diagram for a CM model of a π-model transformer, according to some embodiments of the present disclosure.

FIG. 5C provides an example circuit equivalent diagram for a CM model of a two-impedance model transformer, according to some embodiments of the present disclosure.

FIG. 6A provides an example circuit diagram for a capacitance balance technique for a two-switch forward converter of an original transformer, according to some embodiments of the present disclosure.

FIG. 6B provides an example circuit equivalent diagram for a capacitance balance technique for a two-switch forward converter of a two-capacitor model, according to some embodiments of the present disclosure.

FIG. 7A provides an example circuit diagram for a capacitance balance technique for a flyback converter of an original transformer, according to some embodiments of the present disclosure.

FIG. 7B provides an example circuit equivalent diagram for a capacitance balance technique for a flyback converter of a two-capacitor model, according to some embodiments of the present disclosure.

FIG. 8 provides exemplary curves of a CM voltage gain of a transformer for a flyback converter and a CM voltage gain of a transformer for a two-switch forward converter, according to some embodiments of the present disclosure.

FIG. 9 provides exemplary diagrams for example transformer structures, according to some embodiments of the present disclosure.

FIG. 10 provides exemplary curves of CM impedance of an example transformer, according to some embodiments of the present disclosure.

FIG. 11A provides exemplary curves for parallel CM impedance of an example transformer, according to some embodiments of the present disclosure.

FIG. 11B provides exemplary curves for parallel CM impedance of an example transformer, according to some embodiments of the present disclosure.

FIG. 11C provides exemplary curves for parallel CM impedance of an example transformer, according to some embodiments of the present disclosure.

FIG. 12A provides an example circuit diagram for a setup of a transformer in simulation to investigate CM inductance, according to some embodiments of the present disclosure.

FIG. 12B provides an example circuit equivalent diagram for a setup of a transformer in simulation to investigate CM inductance, according to some embodiments of the present disclosure.

FIG. 13 provides exemplary curves for measured and simulated parallel CM impedance of an example transformer, according to some embodiments of the present disclosure.

FIG. 14 provides an exemplary diagram for a distribution of a magnetic field generated by a current through CM impedance of transformer 1 (T1) at 30 MHz, according to some embodiments of the present disclosure.

FIG. 15A provides an exemplary diagram for a distribution of a magnetic field generated by a current through CM impedance at 30 MHz with different phases, according to some embodiments of the present disclosure.

FIG. 15B provides an exemplary diagram for a distribution of a magnetic field generated by a current through CM impedance at 40.4 MHz with different phases, according to some embodiments of the present disclosure.

FIG. 15C provides an exemplary diagram for a distribution of a magnetic field generated by a current through CM impedance at 50 MHz with different phases, according to some embodiments of the present disclosure.

FIG. 16 provides an exemplary diagram for distribution of a current and a magnetic field vector in different layers, according to some embodiments of the present disclosure.

FIG. 17 illustrates exemplary curves for current amplitudes of a primary winding in layer P1 and layer P2 of a baseline transformer, according to some embodiments of the present disclosure.

FIG. 18 illustrates exemplary curves for current amplitudes of a secondary winding in layer S1 and layer S2 of a baseline transformer, according to some embodiments of the present disclosure.

FIG. 19 provides an example structure diagram for a bifilar winding, according to some embodiments of the present disclosure.

FIG. 20A provides an example circuit structure diagram for a transformer with a primary winding having a bifilar structure, according to some embodiments of the present disclosure.

FIG. 20B provides an example circuit structure diagram for a transformer with a secondary winding having a bifilar structure, according to some embodiments of the present disclosure.

FIG. 21A provides an example circuit structure diagram for a baseline transformer, according to some embodiments of the present disclosure.

FIG. 21B provides an example circuit structure diagram for a transformer with a primary winding having a bifilar structure, according to some embodiments of the present disclosure.

FIG. 21C provides an example circuit equivalent diagram for a transformer with a primary winding having a bifilar structure, according to some embodiments of the present disclosure.

FIG. 22 provides exemplary curves for simulated parallel CM impedance of a baseline transformer and an example transformer with a primary winding having a bifilar structure, according to some embodiments of the present disclosure.

FIGS. 23A and 23B provide exemplary diagrams for comparing magnetic fields generated by an example transformer with a bifilar structure and by a baseline transformer with a same current excitation, according to some embodiments of the present disclosure.

FIG. 24 illustrates exemplary curves for current amplitudes of a primary winding in a baseline transformer and a bifilar transformer, according to some embodiments of the present disclosure.

FIG. 25 illustrates exemplary curves for current amplitudes of a secondary winding in a baseline transformer and a bifilar transformer, according to some embodiments of the present disclosure.

FIG. 26 provides exemplary curves for primary winding impedance and parallel CM impedance of a baseline transformer and an example transformer with a primary winding having a bifilar structure, according to some embodiments of the present disclosure.

FIG. 27 provides exemplary curves for primary winding impedance and parallel CM impedance of a baseline transformer and an example transformer with a primary winding having a bifilar structure, according to some embodiments of the present disclosure.

FIG. 28 provides exemplary curves for a CM voltage gain of a baseline transformer and an example transformer with a primary winding having a bifilar structure, according to some embodiments of the present disclosure.

FIG. 29 provides exemplary curves for CM voltage gain of a baseline transformer and an example transformer with a primary winding having a bifilar structure, according to some embodiments of the present disclosure.

FIGS. 30A and 30B provide exemplary curves for a CM noise of a flyback converter under different balance capacitance conditions of a baseline transformer and an example transformer with a primary winding having a bifilar structure, according to some embodiments of the present disclosure.

FIGS. 31A and 31B provide exemplary curves for a CM noise of a flyback converter under different balance capacitance conditions of a baseline transformer and an example transformer with a primary winding having a bifilar structure, according to some embodiments of the present disclosure.

FIGS. 32A and 32B provide exemplary curves for a CM noise of a two-switch forward converter under different balance capacitance conditions of a baseline transformer and an example transformer with a primary winding having a bifilar structure, according to some embodiments of the present disclosure.

FIGS. 33A and 33B provide exemplary curves for a CM noise of a two-switch forward converter with an output grounded and ungrounded of a baseline transformer and an example transformer with a primary winding having a bifilar structure, according to some embodiments of the present disclosure.

### DETAILED DESCRIPTION

The present disclosure more fully describes various embodiments with reference to the accompanying drawings. It should be understood that some, but not all, embodiments are shown and described herein. Indeed, the embodiments may take many different forms, and accordingly, this disclosure should not be construed as limited to the embodiments set forth herein. Rather, these embodiments are provided so that this disclosure will satisfy applicable legal requirements. Like numbers refer to like elements throughout.

A transformer is a common-mode (CM) noise propagation path in isolated DC-DC converters. Based on a conservation of a displacement current, a CM noise model utilizing the interwinding capacitance to investigate the transformer is discussed herein. For example, four capacitors may be used to provide a transformer CM model. However, currently available CM capacitance models of transformers and relevant capacitance balance techniques might become invalid when the oscillation of CM impedances occurs. An RLC (resistor, inductor, and capacitor) ladder network model may be used to characterize properties of a wideband CM path of the transformers at a circuit level. The results show the RLC ladder network model matches well with a real transformer. Furthermore, two LC (inductor and capacitor) branches may also be used to model the CM path of the transformer based on a two-capacitor CM model.

For example, the inductance of the CM impedance and CM capacitance will oscillate as an excitation frequency of the transformer increases. Based on a distribution of a CM current in the primary winding, a bifilar structure may be applied to the primary winding to reduce inductance of the CM impedance. As such, a first oscillation frequency of CM impedance will be shifted away from 30 MHz. Then an effective range of the two-capacitor CM model and the capacitance balance technique may cover 30 MHz. In various embodiments, experiment results show that the CM noise can be reduced by about 16 dB when a secondary output is grounded or about 11 dB when the secondary output is not grounded.

In some embodiments, switching devices may be CM noise sources and a transformer for galvanic isolation is one of the main propagation paths of a CM noise in isolated DC-DC power converters. For example, a flyback converter and a two-switch forward converter are discussed herein for CM electro-magnetic interference (EMI) analysis of isolated converters.

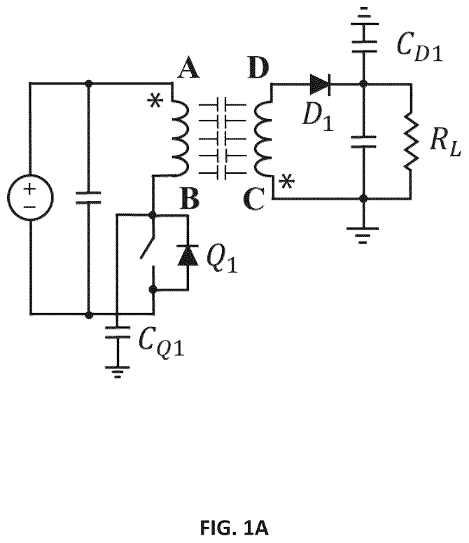

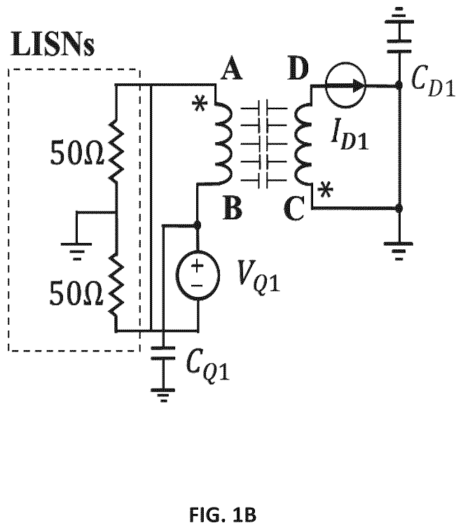

For example, FIG. 1A illustrates an example circuit diagram for a CM model for a flyback converter of a converter circuit with voltage and current sources.

For example, FIG. 1B illustrates an example circuit diagram for a CM model for a flyback converter of substitute nonlinear devices with voltage and current sources.

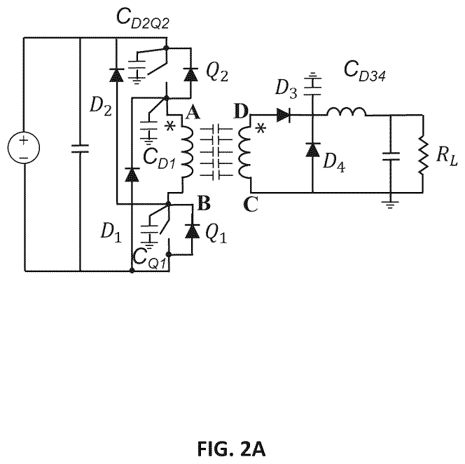

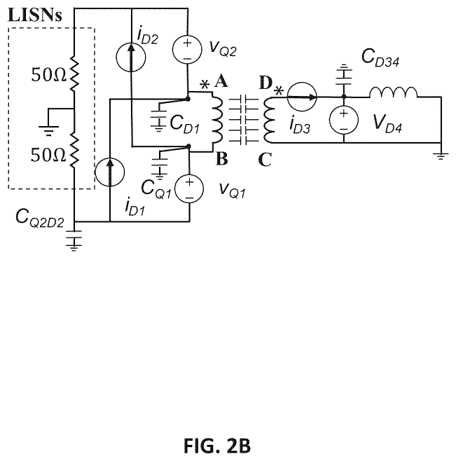

For example, FIG. 2A illustrates an example circuit diagram for a CM model for a two switch forward converter of a converter circuit with voltage and current sources.

For example, FIG. 2B illustrates an example circuit diagram for a CM model for a two switch forward converter of substitute nonlinear devices with voltage and current sources.

In some embodiments, to model a CM noise in isolated converters, switching devices may be replaced with voltage sources or current sources based on a substitution theory. Then, the noise source does not contribute to the CM noise. The modeling CM propagation paths in isolated converters can be applied to eliminate voltage sources or current sources. Complex parasitic parameters of the transformer would make CM noise analysis more challenging. Two CM models (e.g., two-capacitor model and impedance model) of the transformer are used for CM noise analysis.

### Two-Capacitor CM Model of Transformer

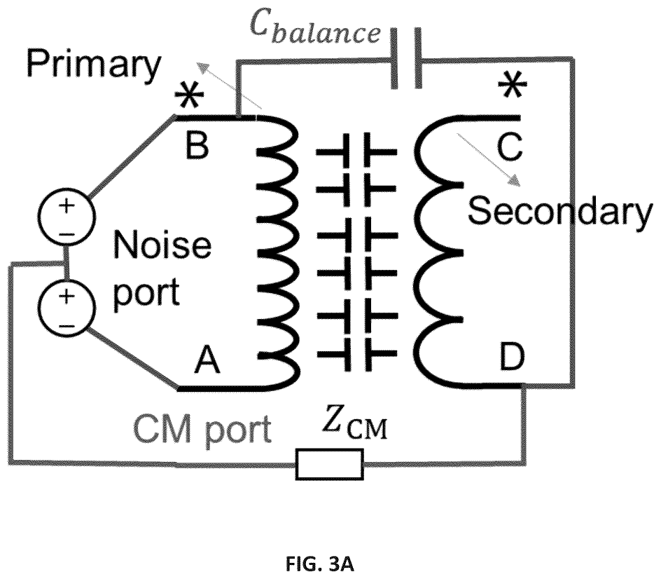

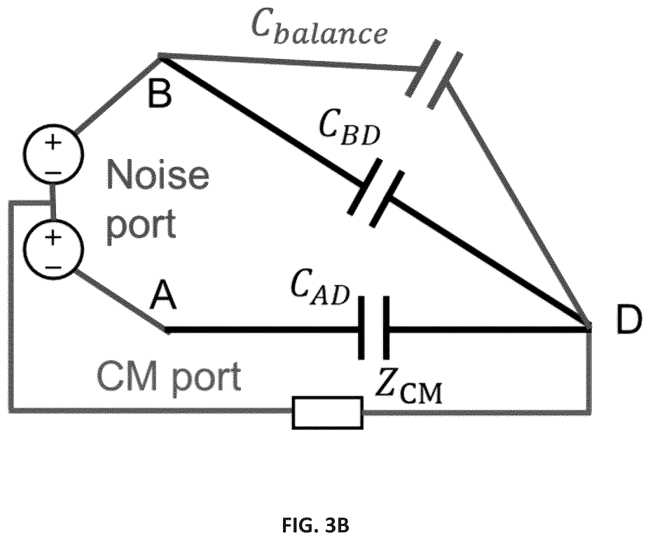

FIG. 3A illustrates an example circuit diagram for a CM model of a transformer for a two-switch forward converter of an original transformer.

FIG. 3B illustrates an example circuit equivalent diagram for a CM model of a transformer for a two-switch forward converter of a two-capacitor model.

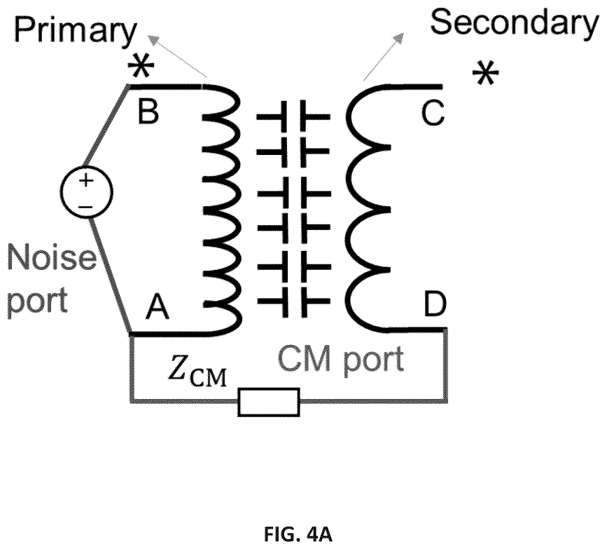

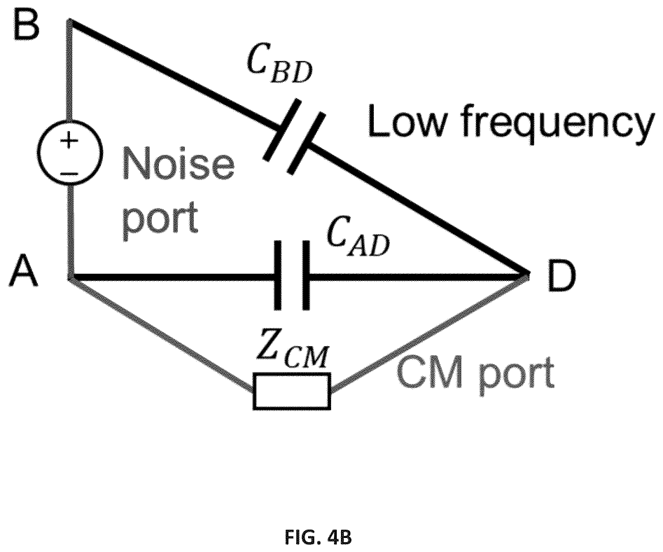

FIG. 4A illustrates an example circuit diagram for a CM model of a transformer for a flyback converter of an original transformer.

FIG. 4B illustrates an example circuit equivalent diagram for a CM model of a transformer for a flyback converter of a two-capacitor model.

In a low-frequency range, two capacitors may be used to model a CM propagation path of a transformer with interwinding capacitance. A CM model of a two-switch forward converter and A CM model of a flyback converter may be simplified by substituting switching devices with voltage sources as the noise sources as shown in FIGS. 3A, 3B, 4A, and 4B. The remaining two-terminal components are equivalent to an impedance ZCM.

The two-capacitor model has advantages, such as simplifying the CM noise analysis and the methods to reduce the CM noise. However, when the excitation frequency of the transformer increases, the two-capacitor model may become invalid and cannot represent the CM propagation path due to oscillations between the interwinding capacitance and the inductive components.

### Two-Impedance CM Model of Transformer

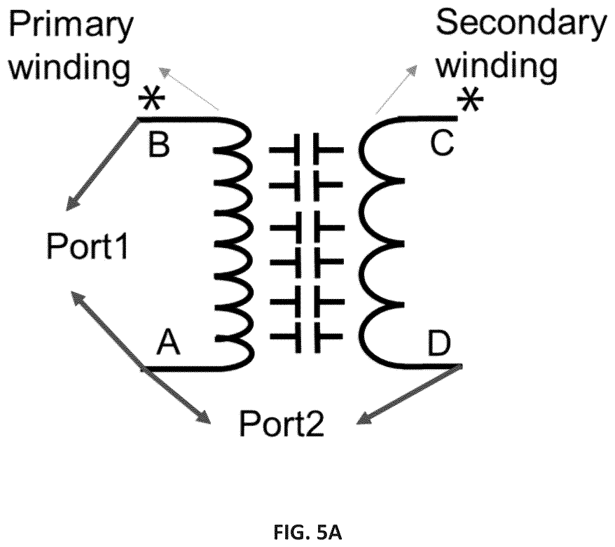

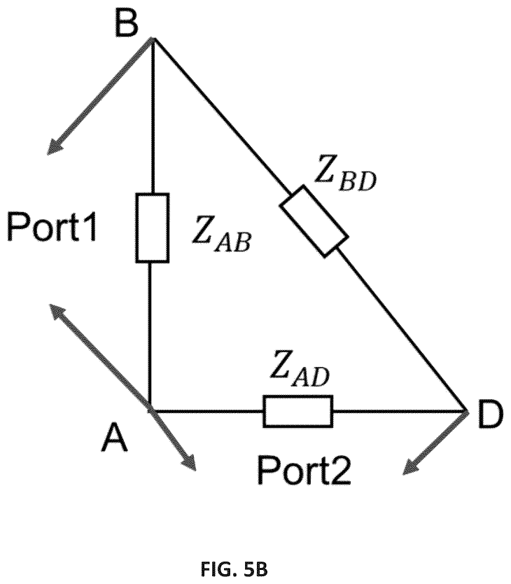

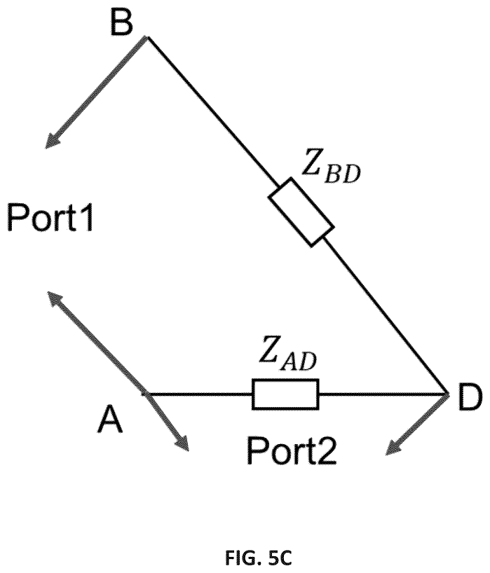

FIG. 5A illustrates an example circuit diagram for a CM model of an original transformer.

FIG. 5B illustrates an example circuit equivalent diagram for a CM model of a π-model transformer.

FIG. 5C illustrates an example circuit equivalent diagram for a CM model of a two-impedance model transformer.

In order to obtain a CM model of a transformer in a wider frequency band, a transformer may be treated as an impedance network. A network theory may be applied to obtain CM impedance of the transformer. For a CM noise analysis of a two-switch forward converter or a flyback converter, the transformer may be treated as a two-port network, as shown in FIG. 5A, FIG. 5B, and FIG. 5C. A π network may be used to represent the CM model of the transformer. When Z_{AB} is parallel to a voltage source, Z_{AB} does not affect the CM noise analysis and can be removed. Impedance Z_{AD} and Z_{BD} can represent the CM model of the transformer.

Although impedance may be able to characterize the CM model of a transformer, the transformer balance techniques to reduce the CM noise will be invalid like the two-capacitor model.

### Capacitance Balance Technique to Reduce CM Noise

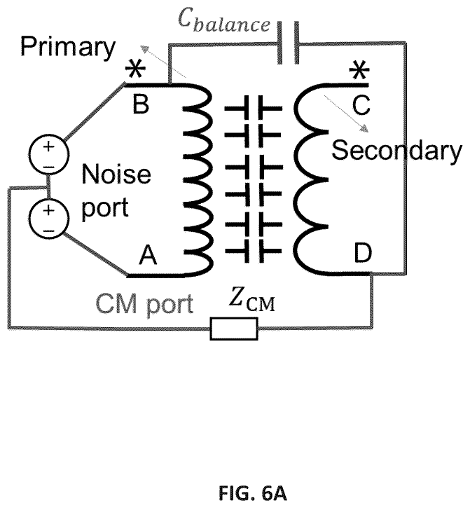

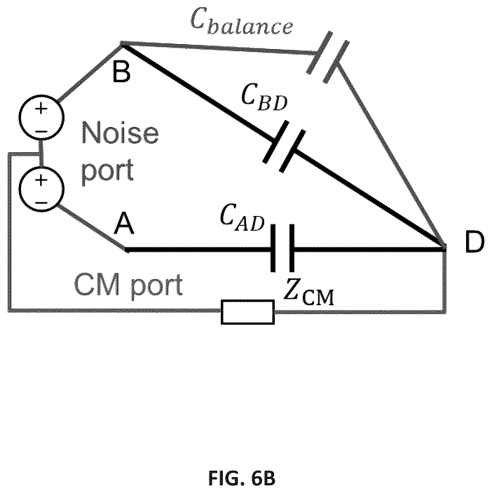

FIG. 6A illustrates an example circuit diagram for a capacitance balance technique for a two-switch forward converter of an original transformer.

FIG. 6B illustrates an example circuit equivalent diagram for a capacitance balance technique for a two-switch forward converter of a two-capacitor model.

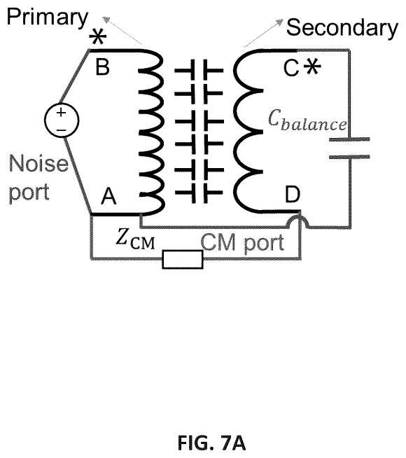

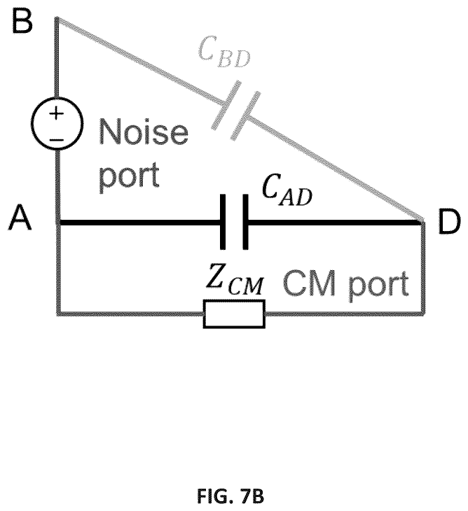

FIG. 7A illustrates an example circuit diagram for a capacitance balance technique for a flyback converter of an original transformer.

FIG. 7B illustrates an example circuit equivalent diagram for a capacitance balance technique for a flyback converter of a two-capacitor model.

Capacitance balance techniques may be classified into two categories. For example, a converter, such as a two-switch forward converter, may have two CM noise sources with a same amplitude and opposite directions. Another capacitor may be added in parallel to Z_{BD} Or Z_{AD} to make branch BD and branch AD have same impedance as shown in FIG. 6A and FIG. 6B. As a result, a CM noise through line impedance stabilization networks (LISNs) will be greatly reduced at a low-frequency range, where CM impedance is capacitive. For example, as shown in FIG. 7A and FIG. 7B, a flyback converter may have another capacitor added between port AC and be tuned to make C_{BD} tend to be zero. Then the CM noise through LISNs will be significantly reduced at the low-frequency range, where CM impedance is capacitive.

CM voltage gain of a transformer may be defined as a ratio of an open-circuit voltage of a CM port to a noise source voltage. For example, CM voltage gain of a transformer for a two-switch forward converter can be calculated by

$${G}_{C M} = \frac{{V}_{open - circuit}}{{V}_{noise}} = \frac{{Z}_{B D} - {Z}_{A D}}{{Z}_{B D} + {Z}_{A D}}$$

CM voltage gain of a transformer for a flyback converter can be calculated by

$${G}_{C M} = \frac{{V}_{open - circuit}}{{V}_{noise}} = \frac{{Z}_{A D}}{{Z}_{B D} + {Z}_{A D}}$$

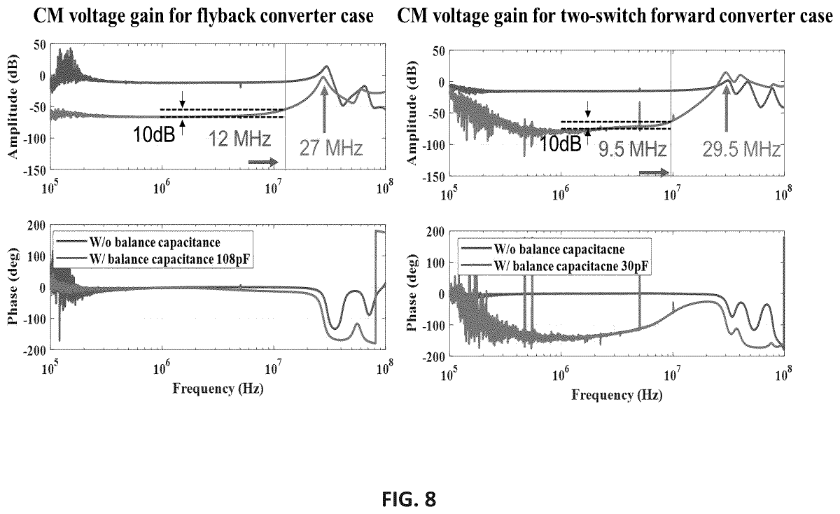

FIG. 8 illustrates exemplary curves of a CM voltage gain of a transformer for a flyback converter and a CM voltage gain of a transformer for a two-switch forward converter.

It should be noted that the two-capacitor model of the transformer has a limited frequency range due to the oscillation of the CM impedance. The capacitance balance technique to reduce the CM noise will be invalid correspondingly. Examples of the CM voltage gain of the transformer for the flyback converter and the CM voltage gain of the transformer for the two-switch forward converter are demonstrated in FIG. 8. When the capacitance balance technique is applied to the transformers, the CM voltage gain may be significantly reduced by 60 dB. However, the CM voltage gain will increase with frequency increasing.

### Analysis Of Magnetic Field Induced by Current Through CM Impedance

In some embodiments, two lumped capacitors may be used in a CM model of a transformer in a low frequency range. However, impedance of the CM model may be transferred from capacitance to inductance according to experimental results. In a physical view, an electrical field between a primary winding and a secondary winding contributes to the lumped capacitors. A CM current through the lumped capacitor is a displacement current. A propagation path of the CM current includes the primary winding, a CM capacitance, and a secondary winding. A magnetic field may be generated when the CM current flows through the primary winding and the secondary winding. The magnetic field may contribute to inductance in the CM path. As a result, the CM inductance will oscillate with the CM capacitance.

### Exemplary Approach to Analyze Magnetic Field Generated by Current through CM Impedance

TABLE I
Structural Parameters of Three Types of
Transformers for Experiment

| Transformer | Core | Core | Primary | Secondary |
|---|---|---|---|---|
| number | type | material | winding | winding |
| Transformer1 | EQ20 | TDK | 40 turns/ | 12 turns/ |
| | | PC40 | AWG30 | AWG26 × 2 |
| Transformer2 | Customized | A-CORE | 30 turns/ | 4 turns/ |
| | | JPP-95 | Litz wire | Litz wire |
| | | | 0.1 mm × 10 | 0.1 mm × |
| | | | | 21 × 3 |
| Transformer3 | EQ30 | TDK | 42 turns/ | 8 turns/ |
| | | PC40 | Litz wire | Litz wire |
| | | | 0.1 mm × 10 | 0.1 mm × |
| | | | | 13 × 3 |

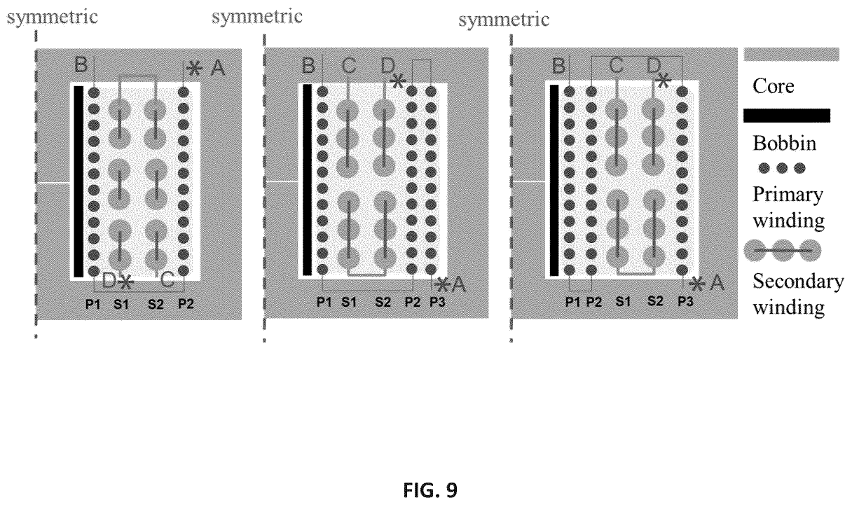

FIG. 9 illustrates exemplary diagrams for example transformer structures.

In the present disclosure, transformer structures are introduced to demonstrate effectiveness of generating a magnetic field by a current through CM impedance. As shown in FIG. 9, each Pᵢ(P₁, P₂ . . . ) indicates a layer of a primary winding and each Sᵢ (S₁, S₂ . . . ) indicates a layer of a secondary winding. Terminals A and D have a same polarity. A transformer may have different winding structures, wires, and cores. Parameters of the transformer are shown in TABLE I.

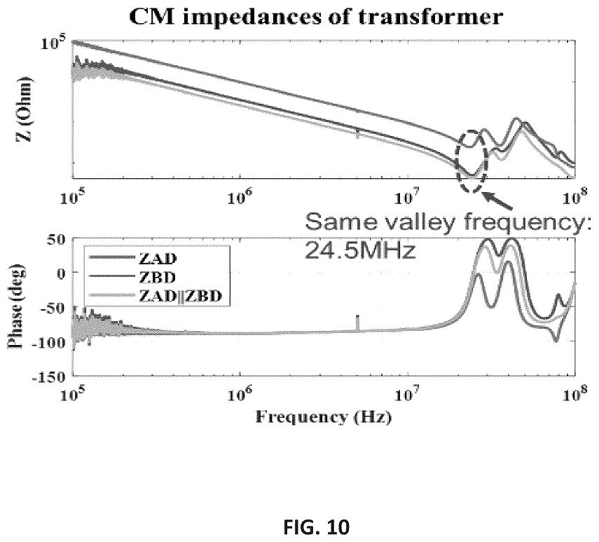

FIG. 10 illustrates exemplary curves of CM impedance of an example transformer.

In the present disclosure, two features are demonstrated in curves of CM impedance. First, as shown in FIG. 10, each of valley oscillations of the curves of the CM impedance have a frequency almost equal to each other. The frequency will be referred as a first valley frequency herein. The feature may be explained by formulas to derive Z-parameters from S-parameters having same nominators. Based on the first feature, the first valley frequency of the CM impedance in parallel would be a focus point to investigate a mechanism of the first valley oscillations of the CM impedance. Second, capacitance of low-frequency CM impedance and the first valley frequency of three example transformers with or without a core are almost the same.

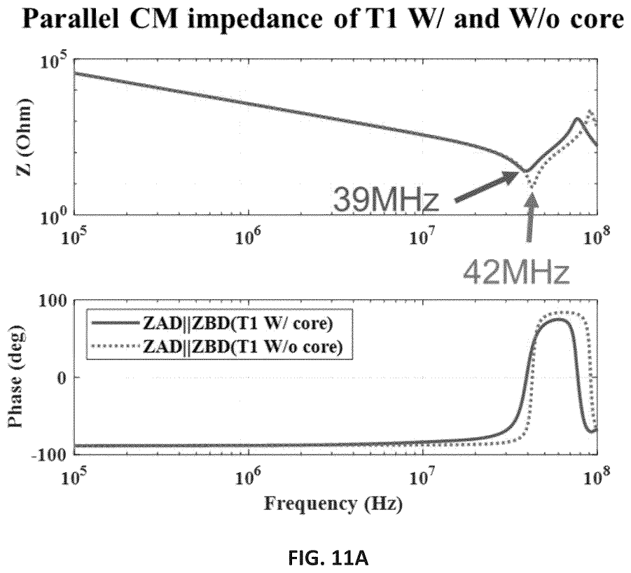

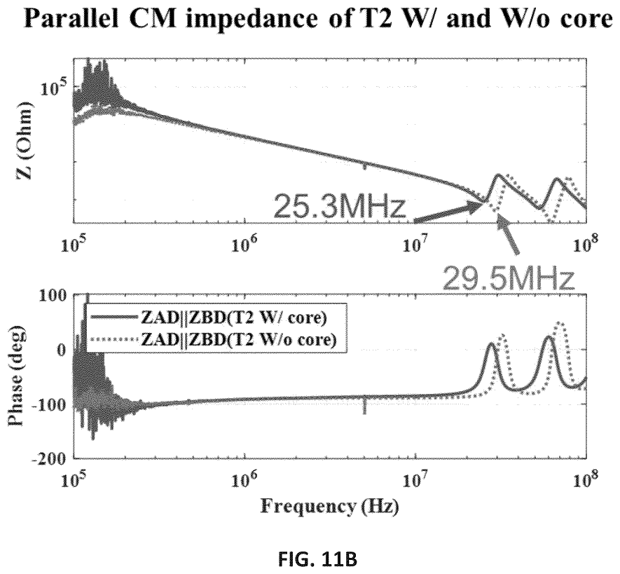

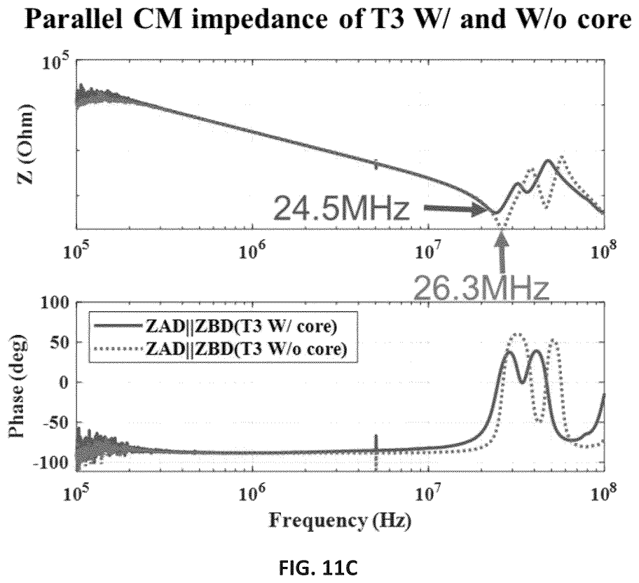

FIG. 11A illustrates exemplary curves for parallel CM impedance of an example transformer. In FIG. 11A, the first valley frequency of transformer 1 (T1) is 39 MHz with a core and 42 MHz without a core.

FIG. 11B illustrates exemplary curves for parallel CM impedance of an example transformer. In FIG. 11B, the first valley frequency of transformer 2 (T2) is 25.3 MHz with a core and 29.5 MHz without a core.

FIG. 11C illustrates exemplary curves for parallel CM impedance of an example transformer. In FIG. 11C, the first valley frequency of transformer 3 (T3) is 24.5 MHz with a core and 26.3 MHz without a core.

The CM capacitance of low-frequency CM impedance is mainly contributed by stored electrical field energy between the primary winding and the secondary winding. A bobbin on which the wire is wound increases the distance between the core and windings. Then the electrical interaction between the core and the windings is negligible. The CM inductance is mainly contributed by a magnetic field in air between layers instead of a magnetic field in a mutual flux path linking the primary winding and the secondary winding. In addition, permeability of the ferrite core will decrease significantly when the excitation frequency of the transformer increases, which may deteriorate the influence of the core on the CM inductance.

In some embodiments, finite element simulation is used to analyze the features of the distribution of the magnetic field generated by a current through CM impedance. To decouple the CM impedance and differential mode (DM) impedance of the transformer, the primary winding (ports A and B) may be shorted in the finite element simulation. In the meanwhile, the magnetic field in the mutual flux path will be negligible because primary ampere-turns and secondary ampere-turns almost cancel each other, as shown below.

N₁i₁+N₂i₂≈0

Here, N₁ is a number of turns of the primary winding and N₂ is a number of turns of the secondary winding. i₁ is a current of the primary winding and i₂ is a current of the second winding, where i₁ and i₂ have opposite phases.

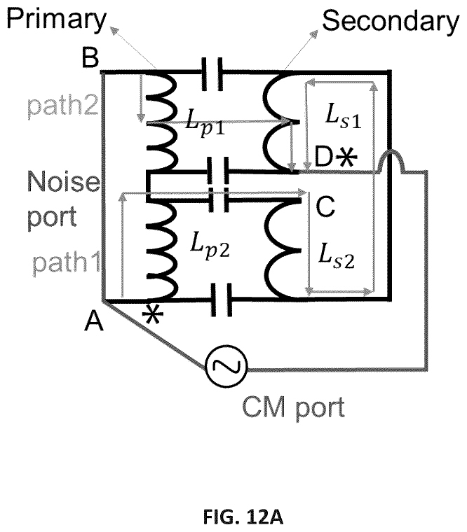

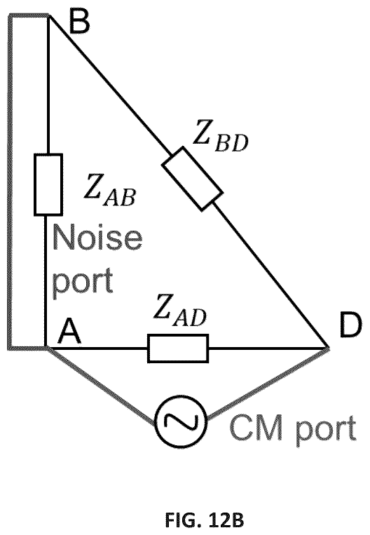

FIG. 12A illustrates an example circuit diagram for a setup of a transformer in simulation to investigate CM inductance.

FIG. 12B illustrates an example circuit equivalent diagram for a setup of a transformer in simulation to investigate CM inductance.

In some embodiments, the CM impedance may be applied in a two-port π model of the transformer. Furthermore, a voltage/current source can be added to the CM port to generate the current flowing through the CM impedance, as shown in FIGS. 12A and 12B. As a result, a magnetic field generated by the current through the CM impedance can be observed in the simulation.

### Exemplary Magnetic Field Generated By Current Through CM Impedance

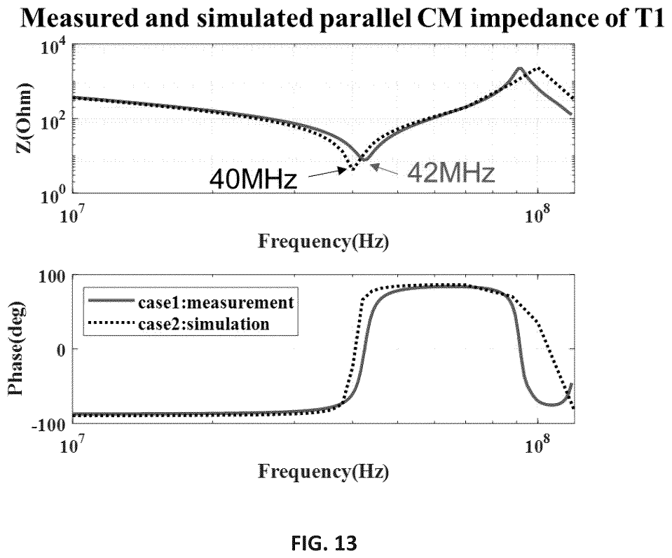

FIG. 13 illustrates exemplary curves for measured and simulated parallel CM impedance of an example transformer.

In the present disclosure, transformer 1 (T1) is built in high frequency simulation software (HFSS) to investigate the magnetic field generated by a current through CM impedance. A voltage source (1V) is added to CM port AD. The simulated impedance is shown in FIG. 13.

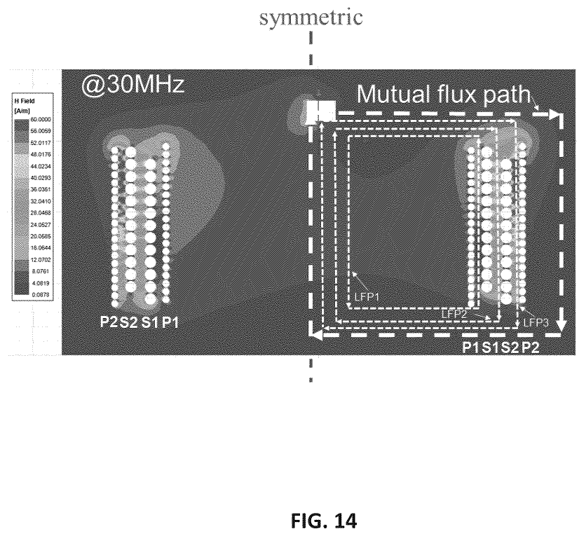

As shown in FIG. 13, a first valley frequency of the simulated parallel CM impedance of transformer 1 is 40 MHz, which matches a first valley frequency of the measured impedance of transformer 1. Although the CM impedance is capacitive when an excitation frequency of the transformer is smaller than the first valley frequency (40 MHZ), the current through the CM impedance will still generate a magnetic field in the windings. When the excitation frequency of the transformer increases, inductive reactance of the CM impedance will increase, and the capacitive reactance of the CM impedance will decrease. When the inductive reactance of the CM impedance and the capacitive reactance of the CM impedance have a same amplitude, first valley oscillation occurs. Sources and features of the magnetic field, which contribute to CM inductance, are investigated herein. Distribution of the magnetic field at 30 MHz is shown in FIG. 14 in order to analyze the origin of the magnetic field contributing to the CM inductance.

FIG. 14 illustrates an exemplary diagram for a distribution of a magnetic field generated by a current through CM impedance of transformer 1 (T1) at 30 MHz.

A magnetic field on a mutual flux path is very small because the primary winding is shorted. It indicates that the inductance of the CM impedance is mainly contributed by a leakage flux in air between layers, and the first valley frequency is very close with or without the core. The leakage flux path is that only links parts of the primary winding and secondary winding. For example, three leakage flux paths (LFP1, LFP2, LFP3) are shown in FIG. 14. Extremely uneven distribution of leakage magnetic field can be seen in air between layers. A maximum magnetic field may be observed in air between layer P2 and layer S2. A minimum magnetic field may be observed in air between layer S1 and layer P1.

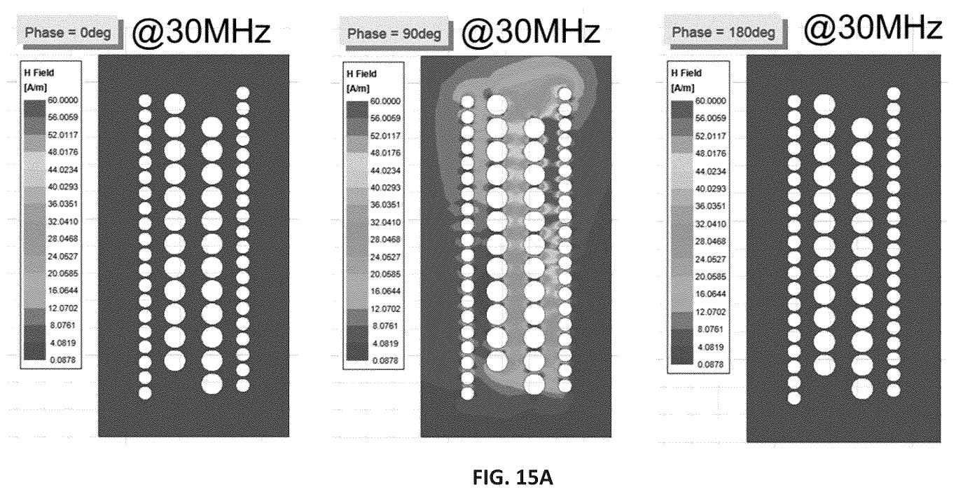

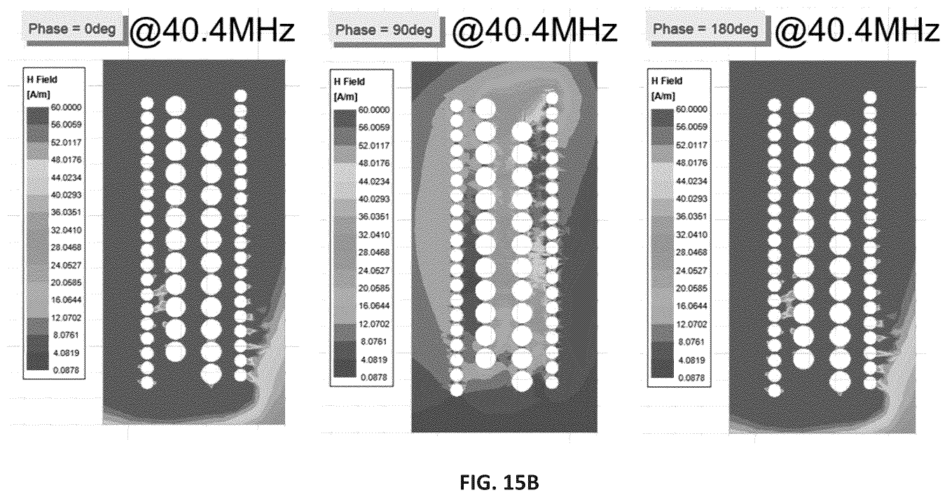

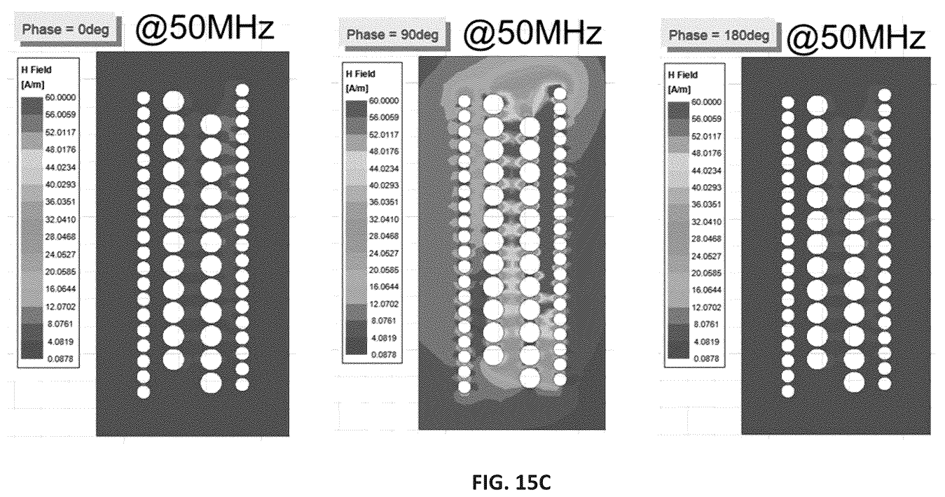

FIG. 15A illustrates an exemplary diagram for a distribution of a magnetic field generated by a current through CM impedance at 30 MHz with different phases.

FIG. 15B illustrates an exemplary diagram for a distribution of a magnetic field generated by a current through CM impedance at 40.4 MHz with different phases.

FIG. 15C illustrates an exemplary diagram for a distribution of a magnetic field generated by a current through CM impedance at 50 MHz with different phases.

Magnetic fields at 30 MHz, 40.4 MHZ, and 50 MHz are shown in FIG. 15A, FIG. 15B, and FIG. 15C, respectively. In the present disclosure, the transformer is symmetric, and only right-side windings will be shown herein for simplification. It should be noted that distributions of leakage magnetic fields at the three frequencies are the same. A strongest magnetic field may be observed at 40.4 MHz when a voltage phase is 0 degree because the CM inductance and the CM capacitance are oscillating at 40.4 MHz.

### Exemplary Current Distribution And Magnetomotive Force

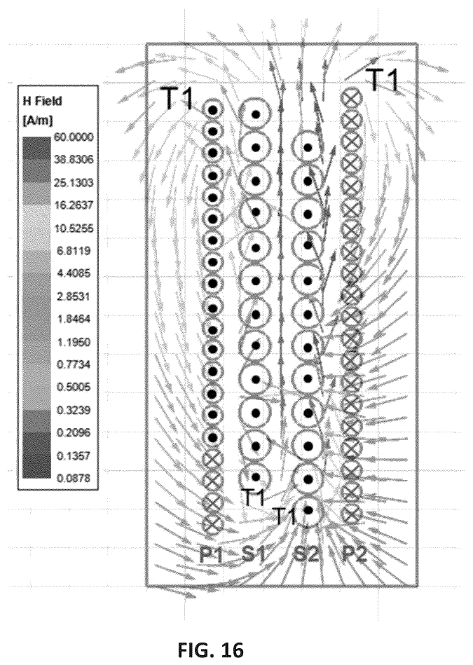

FIG. 16 illustrates an exemplary diagram for distribution of a current and magnetic field vectors in different layers.

Distribution of a current may cause uneven distribution of a leakage magnetic field. A direction of the current in each turn of windings can be obtained in simulations, as shown in FIG. 16. Magnetic field vectors are also shown with each current direction. A dot symbol represents the current flows out of a plane. A cross symbol represents the current flows into the plane. It should be noted that currents in opposite directions are flowing in the primary winding. For example, layer P2 only has cross-currents and layer P1 has both dot-currents and cross-currents. Layer S1 and layer S2 only have dot-currents. A minimum magnetic field may be observed in air between layer P1 and layer S1 since the magnetic field generated by dot-currents and cross-currents in layer P1 cancel each other. A magnetic field generated by the dot-currents in layers S1 and layer S2 and cross-currents in layer P2 will overlay in air between layer S2 and layer P2, and a strongest magnetic field may be observed in air between layer S2 and layer P2.

A magnetomotive force (MMF) of the three leakage flux paths and the mutual flux path is shown in FIG. 16, and the strongest MMF may be observed in air between layer S2 and layer P2.

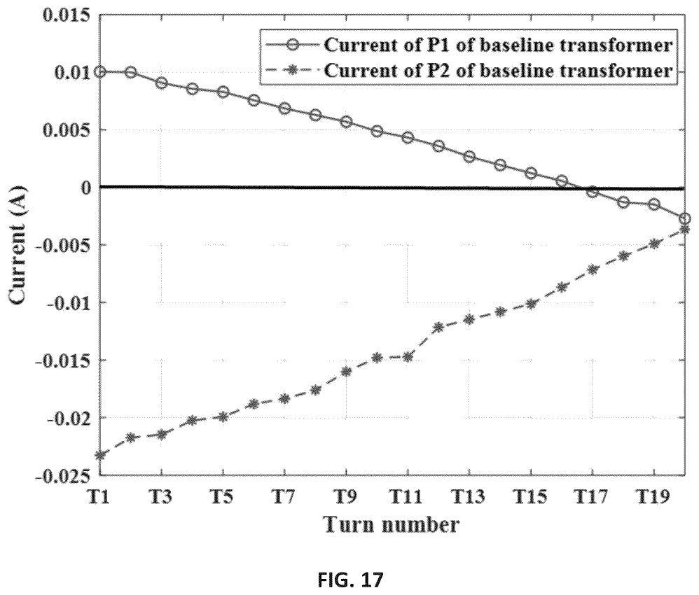

FIG. 17 illustrates exemplary curves for current amplitudes of a primary winding in layer P1 and layer P2 of a baseline transformer.

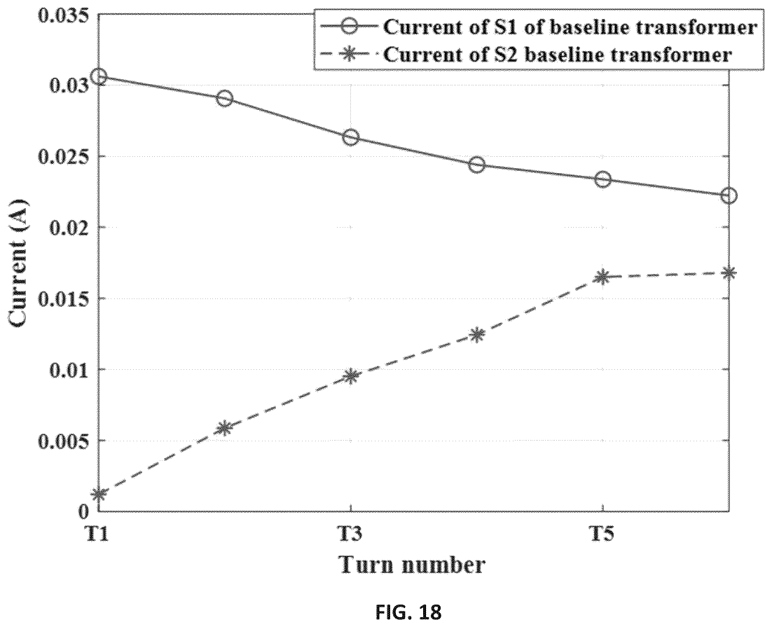

FIG. 18 illustrates exemplary curves for current amplitudes of a secondary winding in layer S1 and layer S2 of a baseline transformer.

### Exemplary Transformer With Primary Winding in Bifilar Structure

Embodiments herein overcome the aforementioned shortcomings and more by presenting the two-capacitor model and a capacitance balance technique. A current through CM impedance distributing in primary winding has two opposite directions. Layer P2 only has cross-currents and layer P1 has dot-currents and cross-currents. In various embodiments, a transformer with an interleaved structure is used to reduce differential mode (DM) leakage inductance. The key principle is using currents in opposite directions to cancel leakages of the magnetic field in air. In some embodiments, a bifilar structure is used in a primary winding of a transformer to make currents in opposite directions spaced alternatively in the primary winding of the transformer. As a result, the leakage magnetic field generated by the current through CM impedance can be reduced, and CM inductance will be decreased. Thus, a wider effective frequency of the two-capacitor model and a capacitance balance technique may be achieved since a frequency of the first valley oscillations of CM impedance is increased.

### Exemplary Transformer With Primary Winding or Secondary Winding in Bifilar Structure

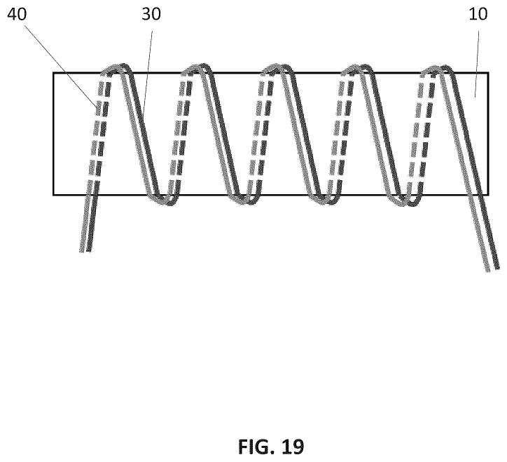

FIG. 19 illustrates an example circuit structure diagram for a bifilar winding.

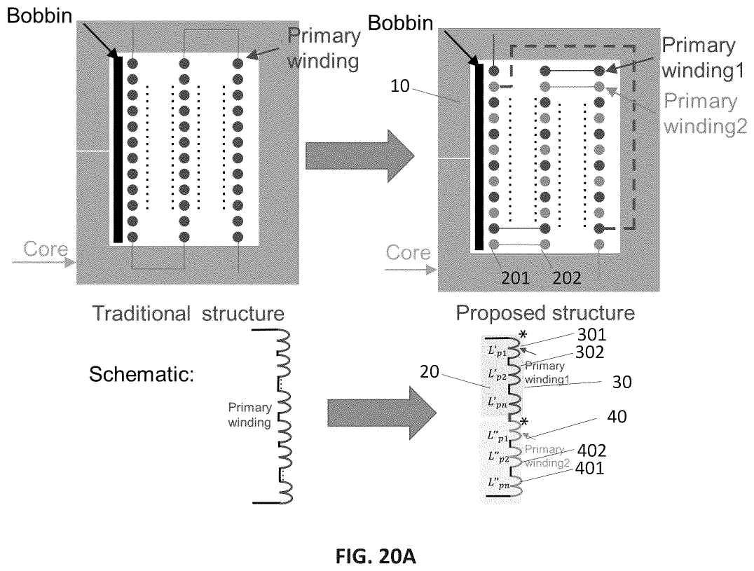

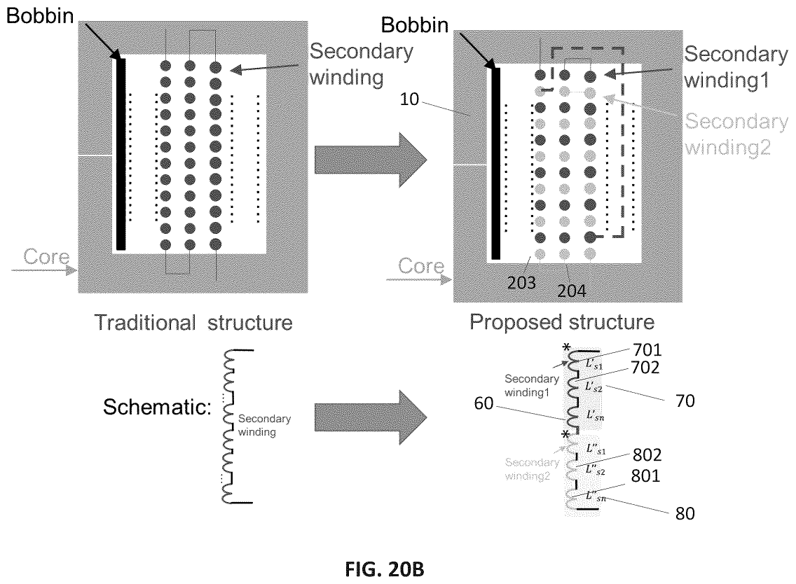

FIG. 20A illustrates an example circuit structure diagram for a transformer with a primary winding having a bifilar structure.

FIG. 20B illustrates an example circuit structure diagram for a transformer with a secondary winding having a bifilar structure.

In order to reduce magnetic field in air, a primary winding may be divided into two parts and then the two parts of the primary winding are bifilar wound, as shown in FIG. 20A. A bifilar structure includes two closely spaced windings.

As shown in FIG. 19, FIG. 20A, and FIG. 20B, a transformer includes a core 10, a primary winding 20, and a secondary winding 60. The primary winding includes a first wire 30 and a second wire 40 electrically connected in series. The first wire 30 and the second wire 40 are bifilar-wound around the core 10. The secondary winding 60 includes a third wire 70 wound around the core 10.

In some embodiments, the transformer further includes a bobbin between the core 10 and the primary winding 20 and between the core 10 and the secondary winding 60.

In some embodiments, the first wire 30 includes a first portion 301 of the first wire 30 and a second portion 302 of the first wire 30. The first portion 301 of the first wire 30 is wound in a first winding layer 201 of the transformer, and the second portion 302 of the first wire 30 is wound in a secondary winding layer 202 of the transformer.

In some embodiments, the second wire 40 includes a first portion 401 of the second wire and a second portion 402 of the second wire. The first portion 401 of the second wire 40 is wound in the first winding layer 201 of the transformer, and the second portion 402 of the second wire 40 is wound in the second winding layer 202 of the transformer.

In some embodiments, the first portion 301 of the first wire 30, the second portion 302 of the first wire 30, the second portion 402 of the second wire 40, and the first portion 401 of the second wire 40 are electrically connected in a sequential order.

In some embodiments, the secondary winding 60 further includes a fourth wire 80 electrically connected with the third wire 70 in series. The third wire 70 and the fourth wire 80 are bifilar-wound around the core.

In some embodiments, the third wire 70 includes a first portion 701 of the third wire 70 and a second portion 702 of the third wire 70. The first portion 701 of the third wire 70 is wound in a third winding layer 203 of the transformer, and the second portion 702 of the third wire 70 is wound in a fourth winding layer 204 of the transformer. The fourth wire 80 includes a first portion 801 of the fourth wire 80 and a second portion 802 of the fourth wire 80. The first portion 801 of the fourth wire 80 is wound in the third winding layer 203 of the transformer, and the second portion 802 of the fourth wire 80 is wound in the fourth winding layer 204 of the transformer.

In some embodiments, the first portion 701 of the third wire 70, the second portion 702 of the third wire 70, the second portion 802 of the fourth wire 80, and the first portion 801 of the fourth wire 80 are electrically connected in a sequential order.

In some embodiments, the core is made of a ferrite material.

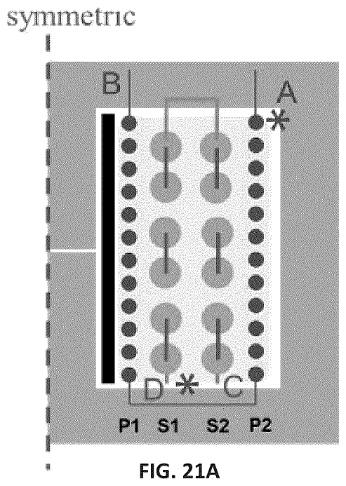

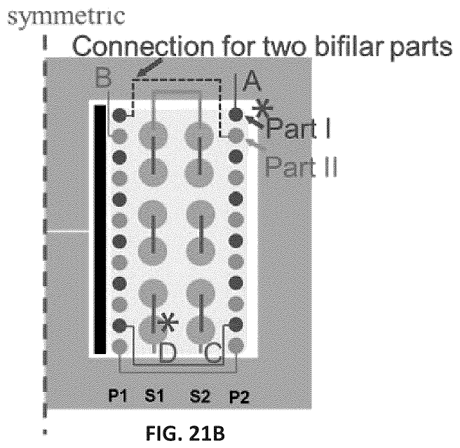

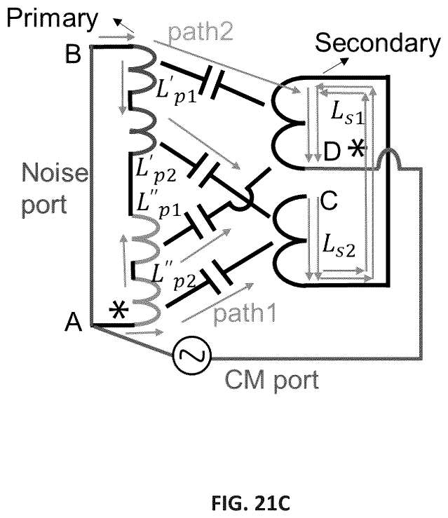

FIG. 21A illustrates an example circuit structure diagram for a baseline transformer.

FIG. 21B illustrates an example circuit structure diagram for a transformer with a primary winding having a bifilar structure.

FIG. 21C illustrates an example circuit equivalent diagram for a transformer with a primary winding having a bifilar structure.

In various embodiments of the present disclosure, the two parts of the primary winding have a strong coupling between each other and a leakage inductance between the two parts of the primary winding is significantly reduced compared to a normal winding. For example, transformer 1 (T1) may have a bifilar structure as shown in FIG. 21B and FIG. 21C. As shown in FIG. 21C, L′p1 represents a part-I winding in layers P1 and L′p2 represents a part-I winding in layers P2, respectively. L″p1 and L″p2 represents a part-II winding in layers Pl and L″p2 represents a part-II winding in layers P2, respectively. When the primary winding is shorted and a source is added to a CM port, a current will flow through the part-I winding and the part-II winding of the primary winding in opposite directions. The current will have a same direction in the secondary winding. Since the magnetic fields generated by currents in opposite directions in each layer of primary winding would cancel each other, a leakage magnetic field in air between layers, such as a leakage magnetic field between layer S2 and layer P2, will be greatly reduced compared to that of a baseline transformer. As a result, a first valley frequency of the CM impedance of the transformer can be increased to widen an effective frequency of the two-capacitor model. Similarly, a bifilar structure can also be applied to the secondary winding for the converters with noise sources on the secondary side, as shown in FIGS. 21A, 21B, and 21C.

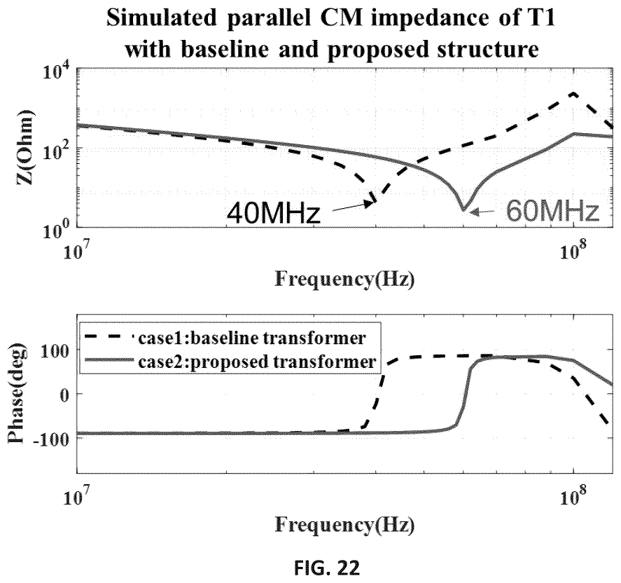

FIG. 22 illustrates exemplary curves for simulated parallel CM impedance of a baseline transformer and an example transformer with a primary winding having a bifilar structure.

When applying a bifilar structure in the primary winding of transformer 1 (T1) in FIG. 9, simulated parallel CM impedance is presented by a solid line in FIG. 22. A first valley frequency is shifted from 40 MHz of a baseline transformer to 60 MHz of a transformer with a primary winding having a bifilar structure. As such, the bifilar primary winding can reduce the CM inductance.

### Comparison of Magnetic Field between Baseline Transformer and Bifilar Transformer

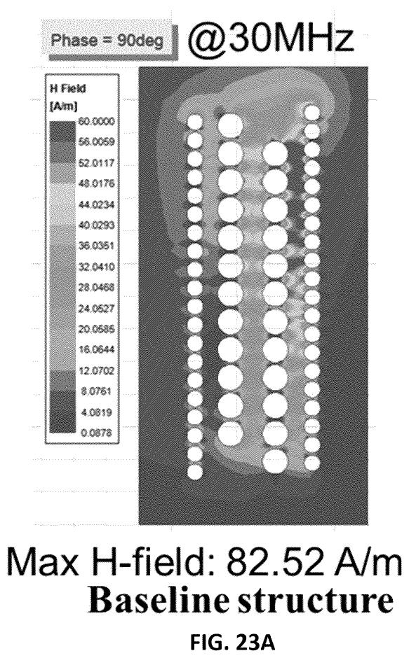

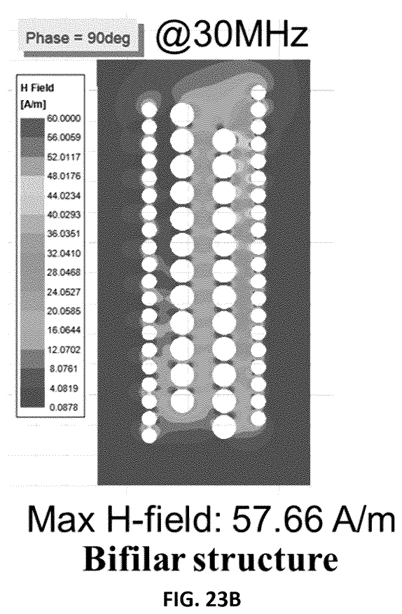

FIGS. 23A and 23B illustrate exemplary diagrams for comparing magnetic fields generated by an example transformer with a bifilar structure and by a baseline transformer with a same current excitation.

A comparison of magnetic fields of an example transformer with a bifilar structure and a baseline transformer under a same current excitation at 30 MHz is shown in FIGS. 23A and 23B. It can be seen that a magnetic field in air of the example transformer is significantly smaller than that of the baseline transformer. In other words, the example transformer with a bifilar structure has less CM inductance compared to the baseline transformer.

### Comparison of Current between Baseline Transformer and Bifilar Transformer

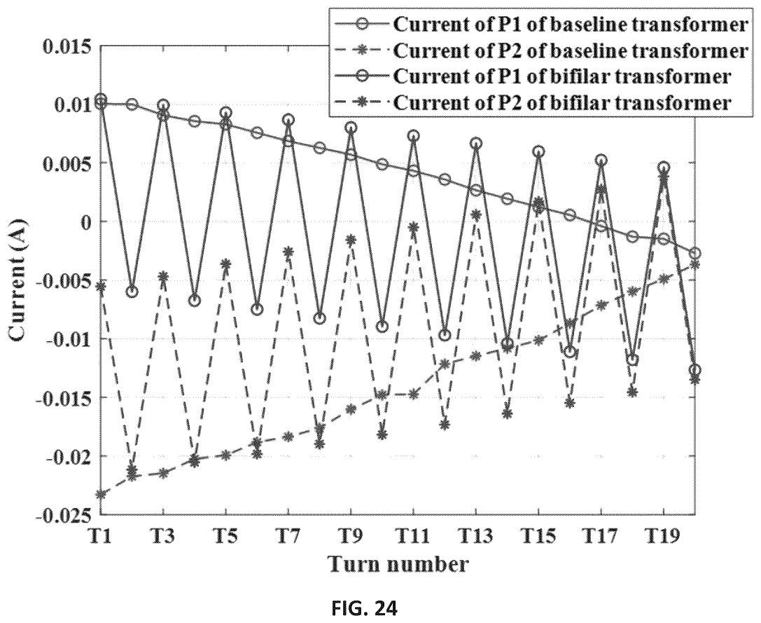

FIG. 24 illustrates exemplary curves for current amplitudes of a primary winding in a baseline transformer and a bifilar transformer.

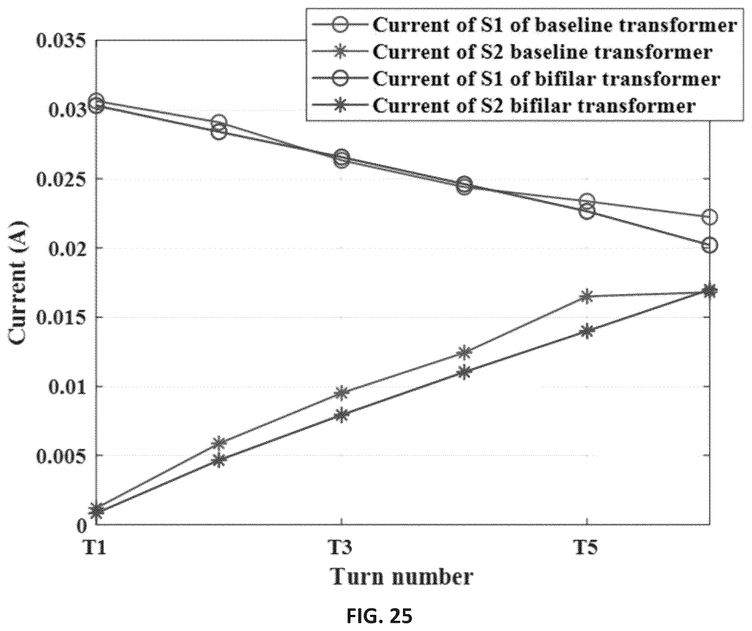

FIG. 25 illustrates exemplary curves for current amplitudes of a secondary winding in a baseline transformer and a bifilar transformer.

A comparison of current amplitudes in a baseline transformer primary winding and a bifilar transformer primary winding is presented in FIG. 24. A comparison of current amplitudes in a baseline transformer secondary winding and a bifilar transformer secondary winding is presented in FIG. 25.

### EXEMPLARY EMBODIMENTS

In order to further validate effectiveness and advantages of a bifilar primary winding technique on CM EMI performance, the bifilar primary winding technique is applied to transformer 2 (T2) and transformer 3 (T3), as presented in FIG. 9. Each transformer has two versions: a baseline primary winding and a bifilar primary winding. Other components in the transformers are the same. Transformer 2 is designed for a 65 W flyback converter and transformer 3 is designed for a 90 W two-switch forward converter. Detailed electrical parameters of the converters are listed in TABLE II.

TABLE II
Electrical Parameters of Flyback and Two-switch
Froward Converters

| Converter | Input | Output | Rated | Transformer |
|---|---|---|---|---|
| type | voltage | voltage | power | type |
| Flyback converter | 110 V | 12 V | 65 W | Transformer 2 |
| Two-switch | 220 V | 24 V | 90 W | Transformer 3 |
| forward converter | | | | |

### Comparison of CM Characteristics Between Baseline Transformer and Bifilar Transformer

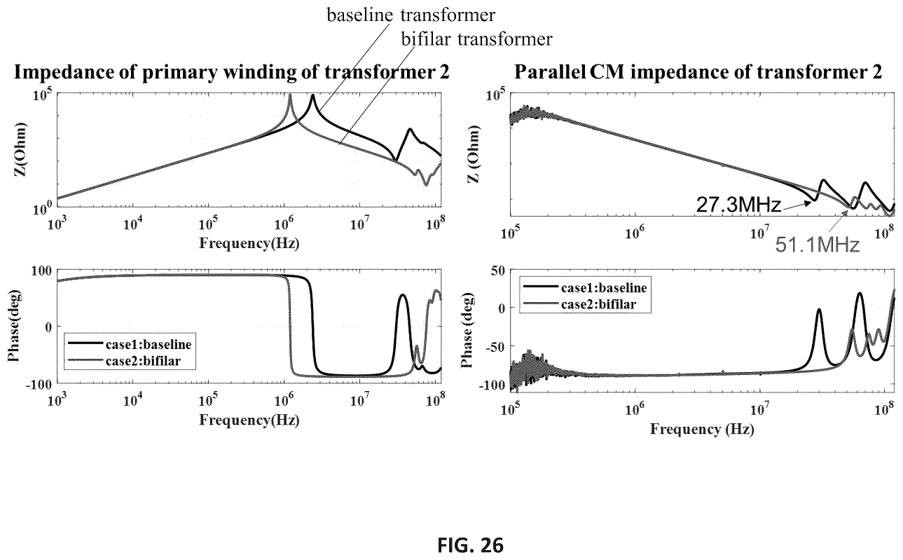

FIG. 26 illustrates exemplary curves for primary winding impedance and parallel CM impedance of a baseline transformer and an example transformer with a primary winding having a bifilar structure.

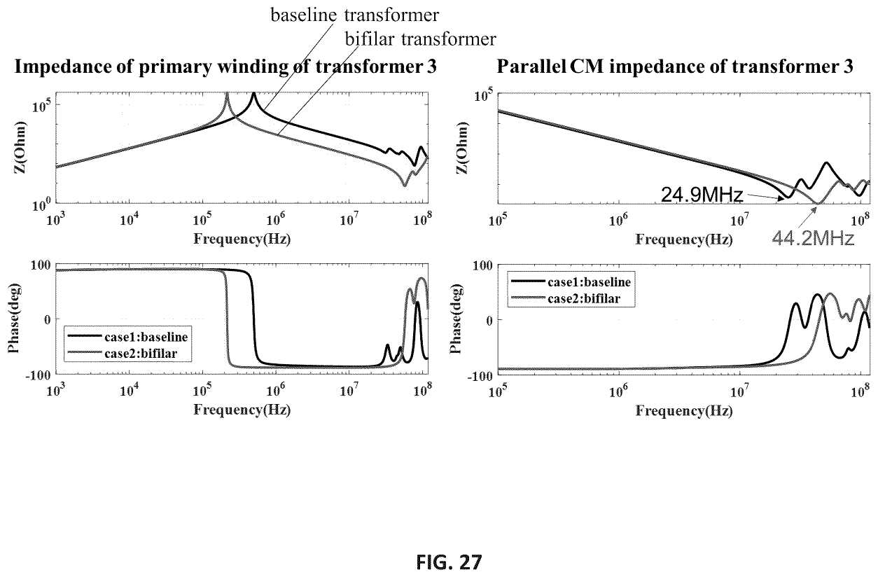

FIG. 27 illustrates exemplary curves for primary winding impedance and parallel CM impedance of a baseline transformer and an example transformer with a primary winding having a bifilar structure.

In order to compare a baseline transformer and a bifilar transformer, primary inductance and CM capacitance of the two transformers should be the same. The primary winding impedance and parallel CM impedance of transformer 2 with a baseline structure and a bifilar structure are shown in FIG. 26. A same primary winding inductance impedance and a same CM parallel impedance are demonstrated in a low frequency range. As for transformer 3, the primary winding inductance with the baseline structure and the primary winding inductance with the bifilar structure are shown in FIG. 27. A same parallel CM impedance of transformer 3 with the baseline structure and the bifilar structure in a low frequency range are also demonstrated in FIG. 27.

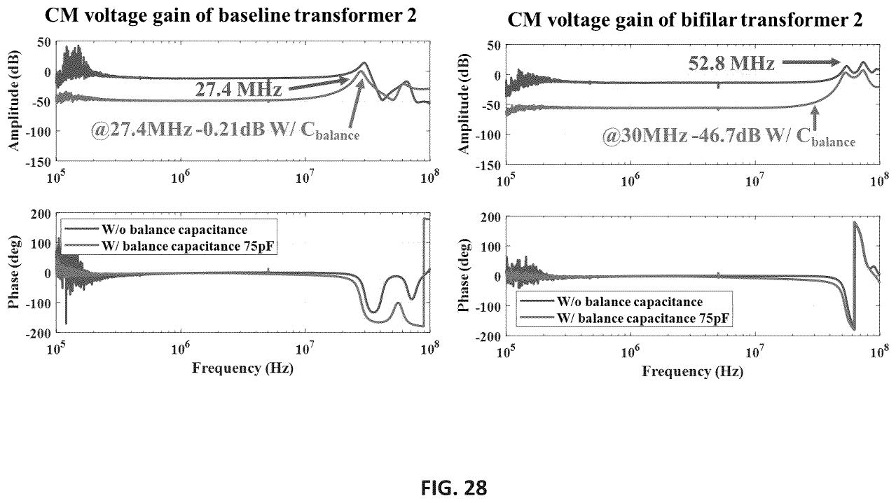

FIG. 28 illustrates exemplary curves for a CM voltage gain of a baseline transformer and an example transformer with a primary winding having a bifilar structure.

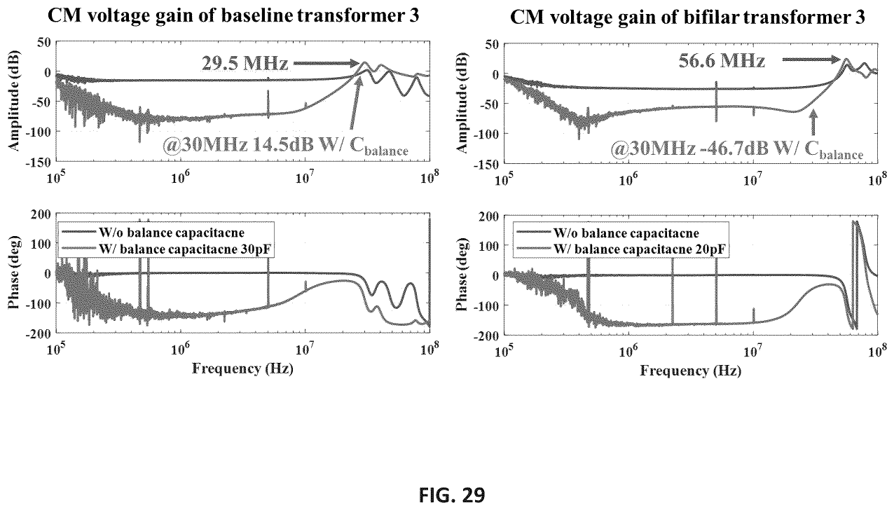

FIG. 29 illustrates exemplary curves for CM voltage gain of a baseline transformer and an example transformer with a primary winding having a bifilar structure.

In various embodiments of the present disclosure, advantages of the bifilar structure are demonstrated by high-frequency characteristics of transformers. For example, transformer 2 has a first valley frequency shifted from 27.3 MHz to 51.1 MHz when a primary winding is changed from a baseline structure to a bifilar structure. For example, transformer 3 has a first valley frequency shifted from 24.9 MHz to 44.2 MHz when a primary winding is changed from a baseline structure to a bifilar structure. An effective frequency range of the two-capacitor model of a bifilar transformer is significantly larger than that of the baseline transformer. The advantages of the transformer on a CM voltage gain with the bifilar structure are indicated in FIG. 28 and FIG. 29. For example, transformer 2 has the CM voltage gain showing a maximum at 27.4 MHz with the baseline structure when a balance capacitance is applied. A maximum CM voltage gain is −0.21dB at 30 MHz. A maximum CM voltage gain of the bifilar transformer 2 is observed at 52.8 MHz, which is significantly larger than that of the baseline transformer 2. The maximum CM voltage gain is −46.7 dB at 30 MHz.

In some embodiments, transformer 3 has frequencies of a maximum CM voltage gains at 29.5 MHz and 56.6 MHz for a baseline transformer 3 and a bifilar transformer 3, respectively. The maximum CM voltage gains for the baseline transformer 3 and bifilar transformer 3 at 30 MHz are 14.5 dB and −46.7 dB, respectively. The results show advantages of the bifilar structure on CM noise attenuation.

### Comparison of Conducted CM EMI of Flyback Converter With Baseline Transformer and Bifilar Transformer

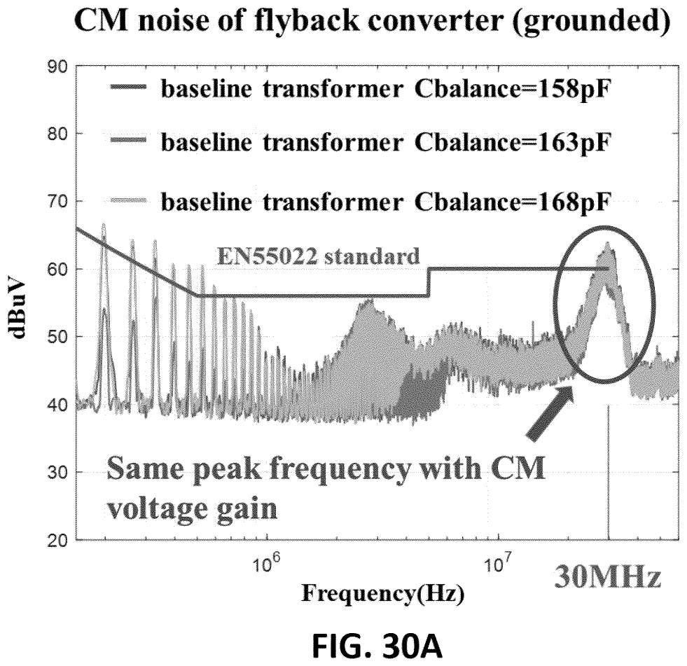

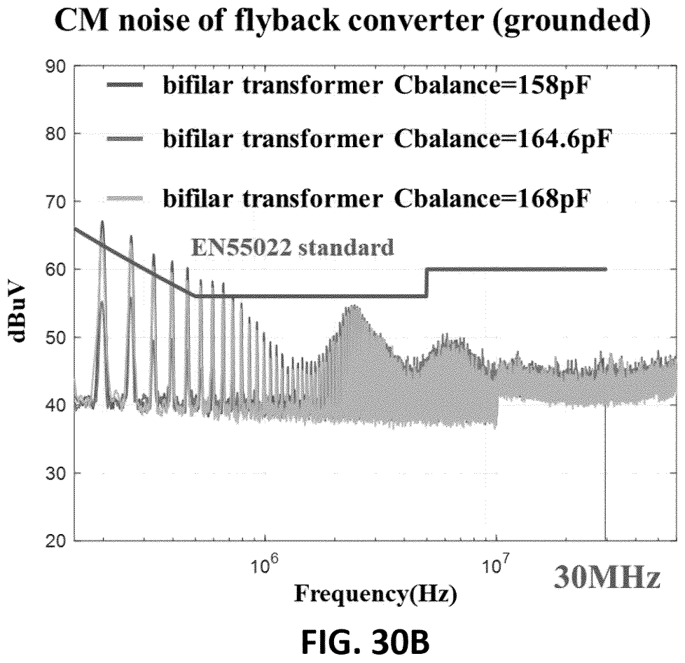

FIGS. 30A and 30B illustrate exemplary curves for a CM noise of a flyback converter under different balance capacitance conditions of a baseline transformer and an example transformer with a primary winding having a bifilar structure.

In order to verify the advantages of the bifilar transformer on the CM EMI noise attenuation, a CM noise from the flyback converter with the baseline transformer 2 and the bifilar transformer 2 are measured respectively, as indicated in FIGS. 30A and 30B. A minimum of the CM noise at a low frequency can be achieved by changing balance capacitance. Optimized balance capacitance for the baseline transformer 2 is 163 pF and optimized balance capacitance for the bifilar transformer 2 is 164.6 pF. A maximum of the CM noise of the baseline transformer 2 can be located near 28 MHz. The maximum of the CM noise keeps unchanged when the balance capacitance increases. In contrast, there is no maximum for the CM noise of the bifilar transformer 2 within 30 MHz.

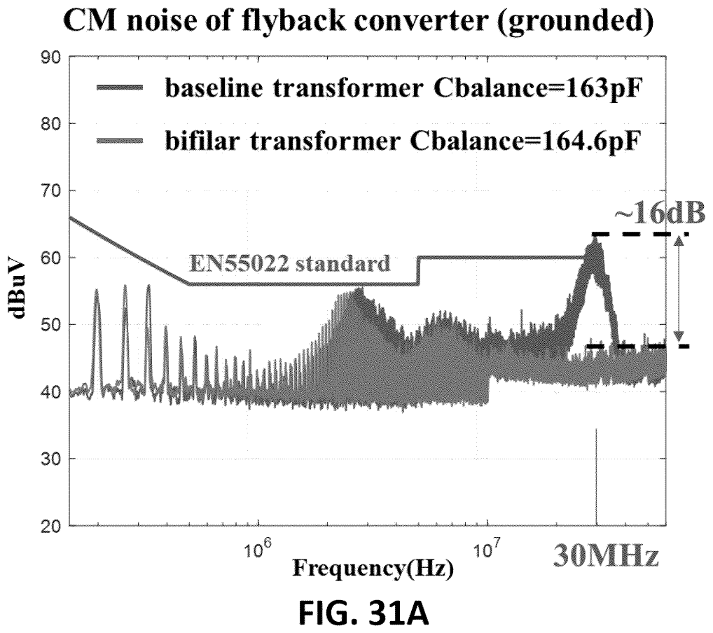

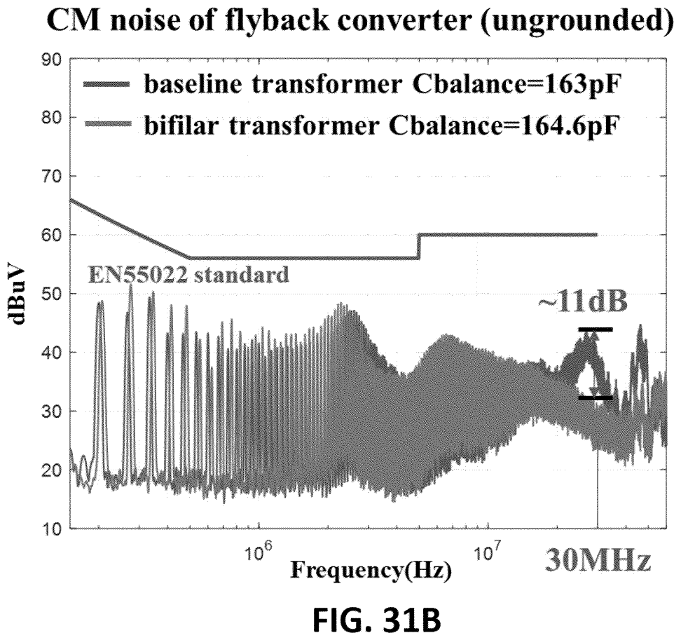

FIGS. 31A and 31B illustrate exemplary curves for a CM noise of a flyback converter under grounded and ungrounded conditions of a baseline transformer and an example transformer with a primary winding having a bifilar structure.

To further compare the CM EMI performance between the baseline transformer and the bifilar transformer, the CM noises of the transformers at the low frequency are tuned to be minimum by changing the balance capacitance. A maximum can be seen near 28 MHz in the CM noise of the baseline transformer regardless of whether an output of the flyback converter is grounded or ungrounded, as shown in FIGS. 31A and 31B. In the case of the bifilar transformer, a 16 dB reduction is observed when the output of the flyback converter is grounded and a 11 dB reduction is observed when the output of the flyback converter is ungrounded.

### Comparison of Conducted CM EMI of Two-Switch Forward Converter With Baseline Transformer and Bifilar Transformer

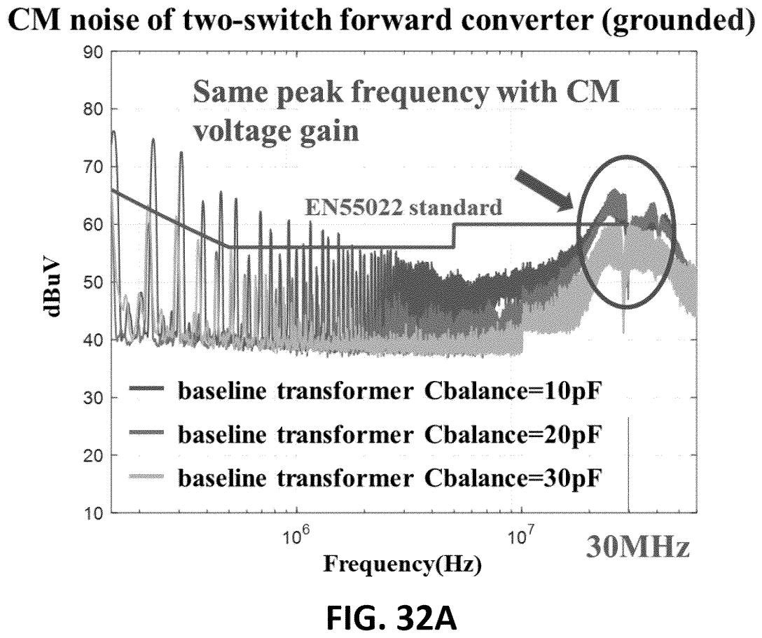

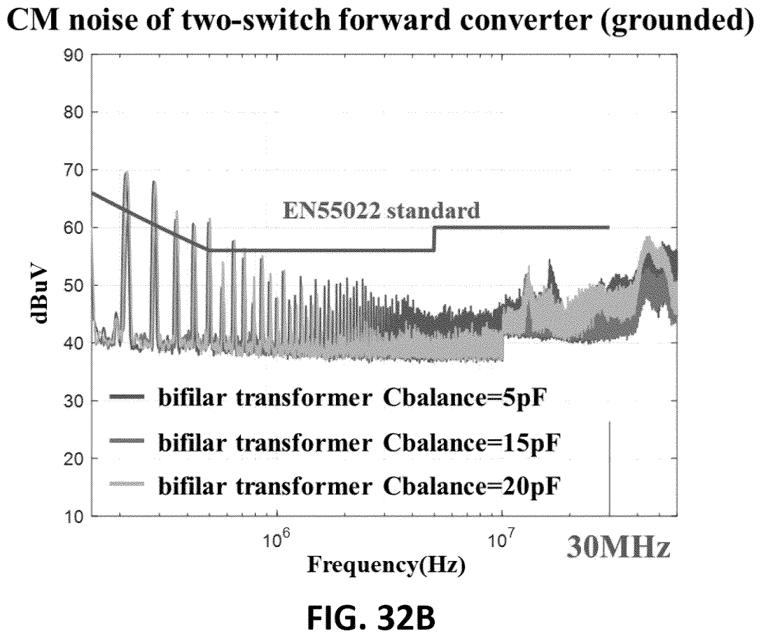

FIGS. 32A and 32B illustrate exemplary curves for a CM noise of a two-switch forward converter under different balance capacitance conditions of a baseline transformer and an example transformer with a primary winding having a bifilar structure.

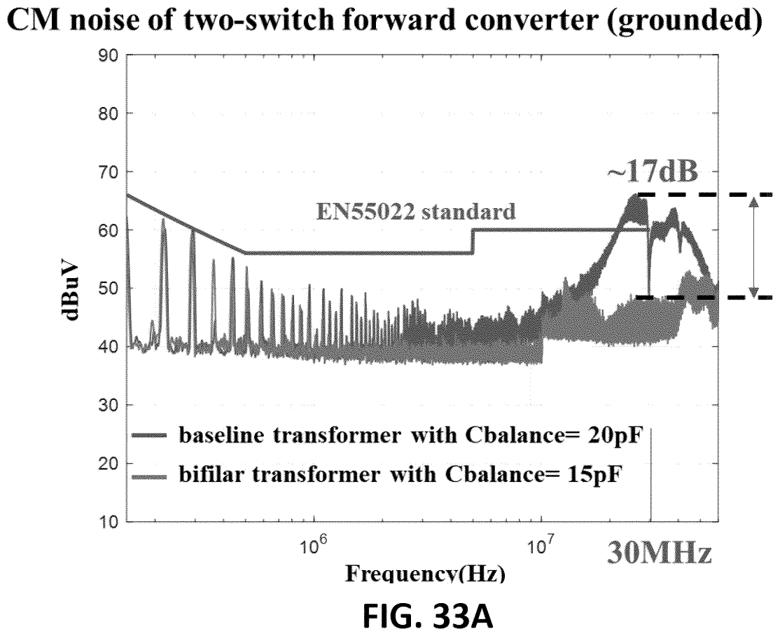

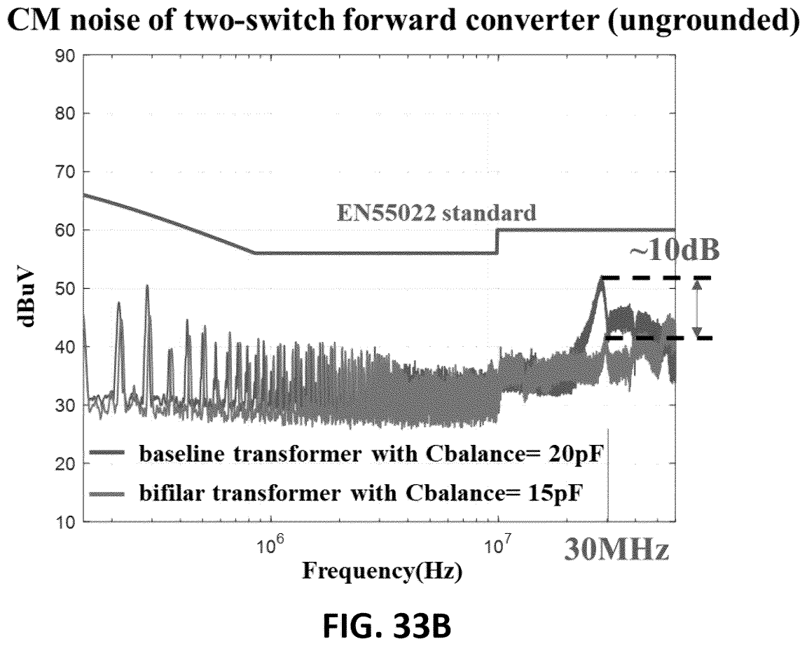

FIGS. 33A and 33B illustrate exemplary curves for a CM noise of a two-switch forward converter with an output grounded and ungrounded of a baseline transformer and an example transformer with a primary winding having a bifilar structure.

In various embodiments, the bifilar transformer is also beneficial to a converter (e.g., a two-switch forward converter), whose CM model has two noise sources with a same amplitude but opposite directions. CM EMI results of a two-switch forward converter of a baseline transformer 3 and a bifilar transformer 3 are shown in FIGS. 32A and 32B. A CM noise at low frequency range can be effectively reduced by tuning balance capacitance. Optimized balance capacitance for the baseline transformer 3 is 20 pF and optimized balance capacitance for the bifilar transformer 3 is 15 pF. The maximum CM noise can be observed at about 29 MHz for baseline transformer. The variation of balance capacitance has less impact on the maximum CM noise. In terms of the bifilar transformer, a much smaller CM noise maximum compared to the baseline transformer can be observed at about 45 MHz. A further comparison of CM noise between the baseline transformer and the bifilar transformer is shown in FIGS. 33A and 33B with the output of the two-switch forward converter grounded and ungrounded. The low-frequency CM noise for the baseline transformer and the bifilar transformer are tuned closely by changing the balance capacitance. 17 dB and 10 dB reduction of CM noise at a high frequency can be observed in the grounded and ungrounded cases, respectively. It verifies the advantages of the bifilar transformer on CM noise attenuation.

In various embodiments of the present disclosure, CM impedance is used to represent a CM model of a transformer according to a network theory. The CM impedance is transferred from capacitance to inductance when the excitation frequency of the transformer increases. The distribution of the magnetic field generated by a current through the CM impedance is analyzed. As such, a transformer with a bifilar primary/secondary winding is presented and the CM impedance of the transformer has a higher oscillating frequency. As a result, an effective frequency of the CM model of transformer may be extended and a capacitance balance technique is presented herein. The experimental results of the impedance curve and the CM noise curves verify the correctness of the theory and the advantages of the transformer structure.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A transformer comprising:
a core;
a primary winding comprising a first wire and a second wire electrically connected in series, wherein the first wire and the second wire are bifilar-wound around the core; and
a secondary winding comprising a third wire wound around the core.

2. The transformer of claim 1, further comprising:
a bobbin between the core and the primary winding and between the core and the secondary winding.

3. The transformer of claim 1, wherein:
the first wire comprises a first portion of the first wire and a second portion of the first wire,
the first portion of the first wire is wound in a first winding layer of the transformer, and the second portion of the first wire is wound in a second winding layer of the transformer.

4. The transformer of claim 3, wherein:
the second wire comprises a first portion of the second wire and a second portion of the second wire,
the first portion of the second wire is wound in the first winding layer of the transformer, and the second portion of the second wire is wound in the second winding layer of the transformer.

5. The transformer of claim 4, wherein the first portion of the first wire, the second portion of the first wire, the second portion of the second wire, and the first portion of the second wire are electrically connected in a sequential order.

6. The transformer of claim 1, wherein the secondary winding further comprises a fourth wire electrically connected with the third wire in series, wherein the third wire and the fourth wire are bifilar-wound around the core.

7. The transformer of claim 6, wherein:
the third wire comprises a first portion of the third wire and a second portion of the third wire,
the first portion of the third wire is wound in a third winding layer of the transformer, and the second portion of the third wire is wound in a fourth winding layer of the transformer.

8. The transformer of claim 7, wherein:
the fourth wire comprises a first portion of the fourth wire and a second portion of the fourth wire,
the first portion of the fourth wire is wound in the third winding layer of the transformer, and the second portion of the fourth wire is wound in the fourth winding layer of the transformer.

9. The transformer of claim 8, wherein
the first portion of the third wire, the second portion of the third wire, the second portion of the fourth wire, and the first portion of the fourth wire are electrically connected in a sequential order.

10. The transformer of claim 1, wherein the core is made of a ferrite material.

11. A transformer, comprising:
a core;
a secondary winding comprising a first wire and a second wire electrically connected in series, wherein the first wire and the second wire are bifilar-wound around the core; and
a primary winding comprising a third wire wound around the core.

12. The transformer of claim 11, further comprising:
a bobbin between the core and the primary winding and between the core and the secondary winding.

13. The transformer of claim 11, wherein the first wire comprises a first portion of the first wire and a second portion of the first wire, the first portion of the first wire is wound in a first winding layer of the transformer, and the second portion of the first wire is wound in a second winding layer of the transformer.

14. The transformer of claim 13, wherein the second wire includes a first portion of the second wire and a second portion of the second wire, the first portion of the second wire is wound in the first winding layer of the transformer, and the second portion of the second wire is wound in the second winding layer of the transformer.

15. The transformer of claim 14, wherein the first portion of the first wire, the second portion of the first wire, the second portion of the second wire, and the first portion of the second wire are electrically connected in a sequential order.

16. The transformer of claim 11, wherein the primary winding further comprises a fourth wire electrically connected with the third wire in series, and wherein the third wire and the fourth wire are bifilar-wound around the core.

17. The transformer of claim 16, wherein the third wire comprises a first portion of the third wire and a second portion of the third wire, the first portion of the third wire is wound in a third winding layer of the transformer, and the second portion of the third wire is wound in a fourth winding layer of the transformer.

18. The transformer of claim 17, wherein the fourth wire comprises a first portion of the fourth wire and a second portion of the fourth wire, the first portion of the fourth wire is wound in the third winding layer of the transformer, and the second portion of the fourth wire is wound in the fourth winding layer of the transformer.

19. The transformer of claim 18, wherein the first portion of the third wire, the second portion of the third wire, the second portion of the fourth wire, and the first portion of the fourth wire are electrically connected in a sequential order.

20. The transformer of claim 11, wherein the core is made of a ferrite material.
